(19) United States
(12) Patent Application Publication
(10) Pub. No.: US 2017/0097985 A1
(43) Pub. Date: Apr. 6, 2017

(54) INFORMATION PROCESSING APPARATUS, INFORMATION PROCESSING METHOD, AND PROGRAM

(71) Applicant: SONY CORPORATION, TOKYO (JP)

(72) Inventor: MASANORI MIYAHARA, TOKYO (JP)

(73) Assignee: Sony Corporation, Tokyo (JP)

(21) Appl. No.: 15/311,673

(22) PCT Filed: Mar. 10, 2015
(86) PCT No.: PCT/JP2015/056998

§ 371 Date: Nov. 16, 2016

(30) Foreign Application Priority Data
Jun. 13, 2014 (JP) 2014-121999

(51) Int. Cl. G06F 17/30

(52) U.S. Cl. CPC G06F 17/30604; G06F 17/30554; G06F 17/3053

(57) ABSTRACT

[Object] To provide information more useful to users by applying an estimation model for a relation between items more widely. [Solution] There is provided an information processing apparatus including: a status information acquisition unit configured to acquire information representing a first situation of a user and information representing a second situation of the user; a status feature quantity extraction unit configured to extract a first status feature quantity corresponding to the first situation and a second status feature quantity corresponding o the second situation; a result information acquisition unit configured to acquire information indicating a first result generated in the first situation; a result feature quantity extraction unit configured to extract a result feature quantity corresponding to the first result; a relation feature quantity generation unit configured to generate a relation feature quantity indicating a relation between the first situation and the first result on the basis of the first status feature quantity and the result feature quantity; a result estimation unit configured to estimate a second result generated in the second situation on the basis of the relation feature quantity and the second status feature quantity; and an information generation unit configured to generate information reflecting the second result.

### CROSS REFERENCE TO RELATED APPLICATIONS

This application is a U.S. National Phase of International Patent Application No. PCT/JP2015/056998 filed on Mar. 10, 2015, which claims priority benefit of Japanese Patent Application No. JP 2014-121999 filed in the Japan Patent Office on Jun. 13, 2014. Each of the above-referenced applications is hereby incorporated herein by reference in its entirety.

### TECHNICAL FIELD

The present disclosure relates to an information processing apparatus, an information processing method, and a program.

### BACKGROUND ART

In recent years, new filtering methods that are not limited to collaborative filtering (CF) and contents based filtering (CBF) have been proposed. For example, Patent Literature 1 describes technology for searching content recommended to a user on the basis of a relation feature quantity indicating a relation between two contents selected by the user in the past and a feature quantity of content newly selected by the user using a model called four-term analogy.

### CITATION LIST

### Patent Literature

Patent Literature 1: JP 2012-208604A

### SUMMARY OF INVENTION

### Technical Problem

The technology described in Patent Literature 1 is useful. However, a thinking process called analogy is not limited to tastes of content and appears in various aspects. Therefore, if information is generated using relation estimation results with respect to a wider range of items without being limited to the example of Patent Literature 1, it is expected that information more useful to users will be provided.

Accordingly, the present disclosure provides a novel and improved information processing apparatus, information processing method and program which may provide information more useful to users by applying an estimation model for a relation between items more widely.

### Solution to Problem

According to the present disclosure, there is provided an information processing apparatus including: a status information acquisition unit configured to acquire information representing a first situation of a user and information representing a second situation of the user; a status feature quantity extraction unit configured to extract a first status feature quantity corresponding to the first situation and a second status feature quantity corresponding o the second situation; a result information acquisition unit configured to acquire information indicating a first result generated in the first situation; a result feature quantity extraction unit configured to extract a result feature quantity corresponding to the first result; a relation feature quantity generation unit configured to generate a relation feature quantity indicating a relation between the first situation and the first result on the basis of the first status feature quantity and the result feature quantity; a result estimation unit configured to estimate a second result generated in the second situation on the basis of the relation feature quantity and the second status feature quantity; and an information generation unit configured to generate information reflecting the second result.

According to the present disclosure, there is provided an information processing method including: acquiring information representing a first situation of a user and information representing a second situation of the user; extracting a first status feature quantity corresponding to the first situation and a second status feature quantity corresponding o the second situation; acquiring information indicating a first result generated in the first situation; extracting a result feature quantity corresponding to the first result; generating a relation feature quantity indicating a relation between the first situation and the first result on the basis of the first status feature quantity and the result feature quantity; estimating, by a processor, a second result generated in the second situation on the basis of the relation feature quantity and the second status feature quantity; and generating information reflecting the second result.

According to the present disclosure, there is provided a program for causing a computer to execute functions of: acquiring information representing a first situation of a user and information representing a second situation of the user; extracting a first status feature quantity corresponding to the first situation and a second status feature quantity corresponding o the second situation of the user; acquiring information indicating a first result generated in the first situation; extracting a result feature quantity corresponding to the first result; generating a relation feature quantity indicating a relation between the first situation and the first result on the basis of the first status feature quantity and the result feature quantity; estimating a second result generated in the second situation on the basis of the relation feature quantity and the second status feature quantity; and generating information reflecting the second result.

### Advantageous Effects of Invention

According to the present disclosure as described above, it is possible to provide information more useful to users by applying an estimation model for a relation between items more widely.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a block diagram illustrating an example of the overall configuration of an embodiment of the present disclosure.

FIG. 2A is a block diagram illustrating another example of the overall configuration of an embodiment of the present disclosure.

FIG. 2B is a block diagram illustrating another example of the overall configuration of an embodiment of the present disclosure.

FIG. 3 is a block diagram illustrating an example of a functional configuration of a processing unit according to an embodiment of the present disclosure.

FIG. 4 is an explanatory diagram of a process using a four-term analogy model in an embodiment of the present disclosure.

FIG. 5 is a flowchart illustrating an example of a process of defining a relationship between a situation and a result in an embodiment of the present disclosure.

FIG. 6 is a flowchart illustrating an example of a process of estimating a result in an embodiment of the present disclosure.

FIG. 7 is a block diagram illustrating a first example of a system configuration according to an embodiment of the present disclosure.

FIG. 8 is a block diagram illustrating a second example of a system configuration according to an embodiment of the present disclosure.

FIG. 9 is a block diagram illustrating a third example of a system configuration according to an embodiment of the present disclosure.

FIG. 10 is a block diagram illustrating a fourth example of a system configuration according to an embodiment of the present disclosure.

FIG. 11 is a block diagram illustrating a fifth example of a system configuration according to an embodiment of the present disclosure.

FIG. 12 is a diagram illustrating a client-server system as a detailed example of the system configuration according to an embodiment of the present disclosure.

FIG. 13 is a block diagram illustrating a sixth example of a system configuration according to an embodiment of the present disclosure.

FIG. 14 is a block diagram illustrating a seventh example of a system configuration according to an embodiment of the present disclosure.

FIG. 15 is a block diagram illustrating an eighth example of a system configuration according to an embodiment of the present disclosure.

FIG. 16 is a block diagram illustrating a ninth example of a system configuration according to an embodiment of the present disclosure.

FIG. 17 is a diagram illustrating an example of a system including an intermediate server as a detailed example of the system configuration according to an embodiment of the present disclosure.

FIG. 18 is a diagram illustrating an example of a system including a terminal device serving as a host, as a detailed example of the system configuration according to an embodiment of the present disclosure.

FIG. 19 is a block diagram illustrating a tenth example of a system configuration according to an embodiment of the present disclosure.

FIG. 20 is a block diagram illustrating an eleventh example of a system configuration according to an embodiment of the present disclosure.

FIG. 21 is a block diagram illustrating an example of a hardware configuration of an information processing apparatus according to an embodiment of the present disclosure.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Hereinafter, a description will be given in the following order.

1. Overall configuration
1-1. Input unit
1-2. Processing unit
1-3. Output unit
2. Functional configuration of processing unit
2-1. Overall functional configuration
2-2. Details of processing using four-term analogy model
3. Processing flow
3-1. Definition of relationship between situation and result
3-2. Estimation of result
4. Detailed application examples
5. System configuration
6. Hardware configuration

### 7. Supplement

### 1. OVERALL CONFIGURATION

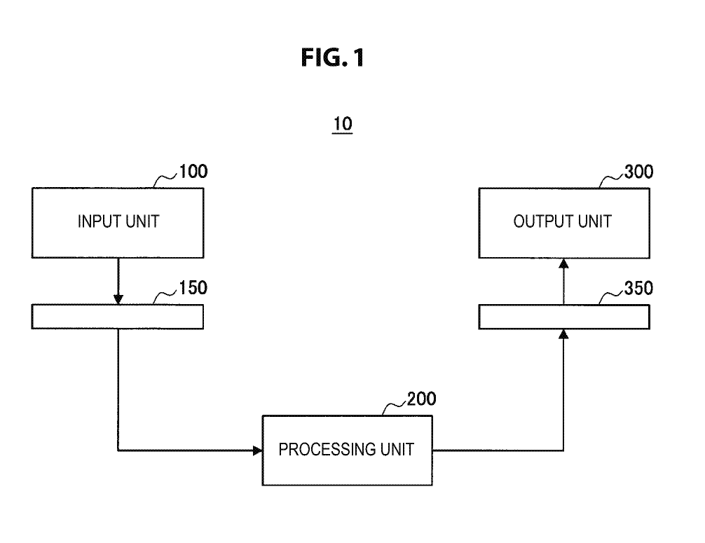

FIG. 1 is a block diagram illustrating an example of the overall configuration of an embodiment of the present disclosure. Referring to FIG. 1, a system 10 includes an input unit 100, a processing unit 200 and an output unit 300. The input unit 100, the processing unit 200 and the output unit 300 are realized by one or more information processing apparatuses as illustrated in examples of the configuration of the system 10, which will be described below.

### (1-1. Input Unit)

For example, the input unit 100 includes a manipulation input device, a sensor, software which obtains information from external services or the like and receives input of various types of information from a user, surrounding environment or other services.

The manipulation input device includes, for example, hardware buttons, a keyboard, a mouse, a touch panel, a touch sensor, a proximity sensor, an acceleration sensor, an angular velocity sensor, temperature sensor or the like and receives manipulation input by the user. In addition, the manipulation input device may include a camera (imaging device), a microphone or the like which receives manipulation input represented by a gesture or voice of the user.

The input unit 100 may include a processor or a processing circuit which converts a signal or data acquired by the manipulation input device into an operation command. Otherwise, the input unit 100 may output the signal or data acquired by the manipulation input device to an interface 150 without converting the signal or data into the operation command. In such a case, the signal or data acquired by the manipulation input device is converted into the operation command in the processing unit 200, for example.

The sensor includes an acceleration sensor, an angular velocity sensor, a terrestrial magnetism sensor, an illuminance sensor, a temperature sensor, an atmospheric pressure sensor or the like and detects acceleration or angular velocity applied to an apparatus, bearing, illuminance, temperature, atmospheric pressure or the like. When an apparatus including the aforementioned sensor is carried by or mounted on a user, for example, the sensor may detect various types of information as information about the user, for example, information indicating movement or direction of the user. In addition, the sensor may include a sensor for detecting bio-information of the user, such as pulse, perspiration, brainwave, tactile sensation, the sense of smell and the sense of taste. The input unit 100 may include a processing circuit for acquiring information representing the emotion of the user by analyzing information detected by such sensors and/or image or audio data detected by a camera or a microphone, which will be described below. Otherwise, the aforementioned information and/or data may be output to the interface 150 without being analyzed and analysis may be performed in the processing unit 200, for example.

Furthermore, the sensor may acquire an image or sound around the user or the apparatus as data using a camera, a microphone, the aforementioned various sensors or the like. In addition, the sensor may include a position detection means for detecting an indoor or outdoor position. Specifically, the position detection means includes a global navigation satellite system (GNSS) receiver, for example, a global positioning system (GPS) receiver, a global navigation satellite system (GLONASS) receiver, a Beidou navigation satellite (BDS) receiver and/or a communication device. The communication device detects a position using technology such as Wi-Fi, MIMO (Multi-Input Multi-Output), cellular communication (e.g., position detection using a mobile base station, femto cell), short range wireless communication (e.g., Bluetooth low energy (BLE)) or Bluetooth (registered trademark)).

When the sensor as described above detects a position or situation of the user (including bio-information), the apparatus including the sensor is carried by or mounted on the user, for example. Otherwise, the sensor may detect a position or situation of the user (including bio-information) even when the apparatus including the sensor is installed in the living environment of the user. For example, it may be possible to detect the pulse of the user by analyzing an image including the face of the user, which is obtained by a camera fixedly installed in an indoor environment or the like.

The input unit 100 may include a processor or a processing circuit for converting a signal or data acquired by the sensor into a predetermined form (e.g., converting an analog signal into a digital signal or encoding image or audio data). Otherwise, the input unit 100 may output the acquired signal or data to the interface 150 without converting the signal or data into the predetermined form. In this case, the signal or data acquired by the sensor is converted into an operation command in the processing unit 200.

The software which acquires information from an external service obtains various types of information provided by the external service, for example, using an application program interface (API) of the external service. For example, the software may acquire information from a server of the external service and may obtain information from service application software executed in a client device. It may be possible to acquire information such as a text and an image loaded by the user or another user to an external service such as social media through the software. The acquired information may not necessarily be information intentionally loaded by the user or another user and may be, for example, a log of operation performed by the user or another user. In addition, the acquired information is not limited to personal information of the user or another user and may be information transmitted to unspecified users, such as news, weather reports, transportation information, point of interest (POI) or advertisements.

Furthermore, the information acquired from the external service may include information generated by detecting information, acquired by the aforementioned various sensors, for example, acceleration, angular velocity, bearing, altitude, illuminance, temperature, atmospheric pressure, pulse, perspiration, brainwave, tactile sensation, the sense of smell, the sense of taste, bio-information, emotion, position information and the like, through a sensor included in another system linked to the external service and loading the detected information to the external service.

The interface 150 is an interface between the input unit 100 and the processing unit 200. When the input unit 100 and the processing unit 200 are implemented as separate devices, for example, the interface 150 may include a wired or wireless communication interface. Furthermore, the Internet may be interposed between the input unit 100 and the processing unit 200. More specifically, the wired or wireless communication interface may include cellular communication such as 3G/LTE, Wi-Fi, Bluetooth (registered trademark), near field communication (NFC), Ethernet (registered trademark), high-definition multimedia interface (HDMI) (registered trademark) and universal serial bus (USB). When at least parts of the input unit 100 and the processing unit 200 are implemented as the same device, the interface 150 may include buses in the device and data reference in a program module (referred to hereinafter as an intra-device interface). If the input unit 100 is implemented by being distributed in a plurality of devices, the interface 150 may include interfaces of different types for the respective devices. For example, the interface 150 may include both a communication interface and an intra-device interface.

### (1-2. Processing Unit)

The processing unit 200 performs various processes on the basis of information acquired through the input unit 100. More specifically, the processing unit 200 includes a processor or a processing circuit, for example, a central processing unit (CPU), a graphics processing unit (GPU), a digital signal processor (DSP), an application specific integrated circuit (ASIC), a field-programmable gate array (FPGA) or the like. In addition, the processing unit 200 may include a memory or a storage device for temporarily or permanently storing programs executed in the processor or the processing circuit and data read and written in processes.

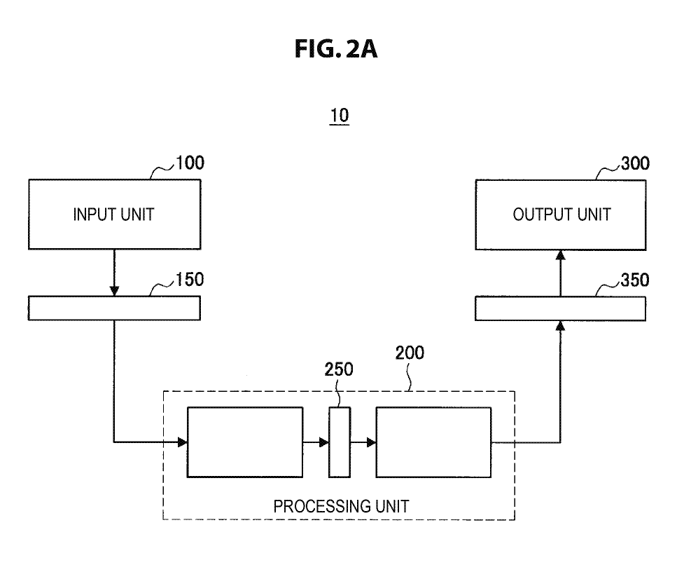

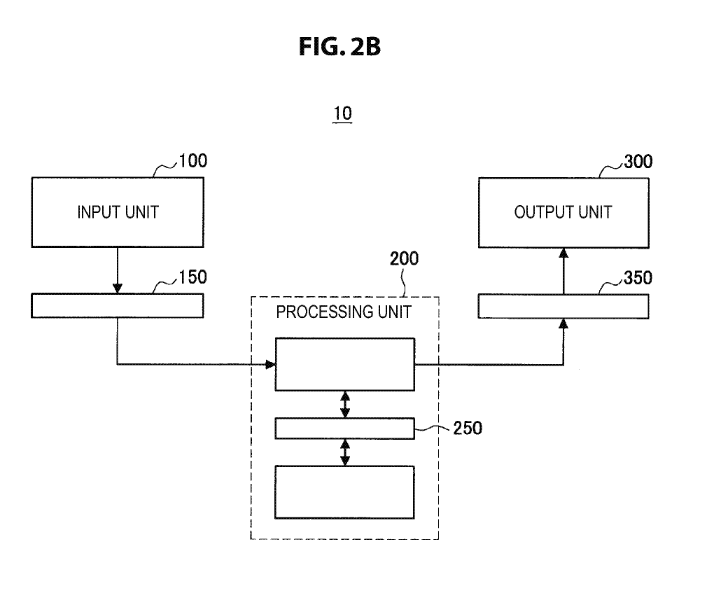

In addition, the processing unit 200 may be implemented as a single processor or processing circuit in a single device or may be implemented by being distributed in a plurality of devices, or a plurality of processors or processing circuits in an identical device. When the processing unit 200 is implemented in a distributed manner, an interface 250 is interposed between distributed parts of the processing unit 200, as illustrated in examples of FIGS. 2A and 2B. The interface 250 may include a communication interface or an intra-device interface, like the aforementioned interface 150. Although individual functional blocks which constitute the processing unit 200 are exemplified in a detailed description of the processing unit 200, which will be described below, the interface 250 may be interposed between arbitrary functional blocks. That is, when the processing unit 200 is implemented by being distributed in a plurality of devices, or a plurality of processors or processing circuits, the functional blocks are arbitrarily allocated to the respective devices, respective processors or respective processing circuits unless otherwise mentioned.

### (1-3. Output Unit)

The output unit 300 outputs information provided by the processing unit 200 to the user (that may be the same user as the user of the input unit 100 or a different user), an external device or other services. For example, the output unit 300 may include software which provides information to an output device, a control device or an external service.

The output device outputs information provided by the processing unit 200 in a form perceived by the sense of the user (that may be the same user as the user of the input unit 100 or a different user), such as the vision, hearing, the sense of touch, the sense of smell and the sense of taste. For example, the output device is a display and outputs information through an image. The display is not limited to reflective type or self-emitting displays such as a liquid crystal display (LCD) and an organic electro-luminescence (EL) display and includes a combination of a light guide member for guiding image display light to the face of the user and a light source, as used for wearable devices and the like. Furthermore, the output device may include a speaker and output information through a sound. In addition, the output device may include a projector, a vibrator and the like.

The control device controls an apparatus on the basis of information provided by the processing unit 200. The controlled apparatus may be included in an apparatus which implements the output unit 300 or may be an external apparatus. More specifically, the control device includes a processor or a processing circuit which generates control commands, for example. When an external apparatus is controlled, the output unit 300 may further include a communication device which transmits control commands to the external apparatus. The control device controls, for example, a printer which outputs information provided by the processing unit 200 as a printed matter. The control device may include a driver which controls writing of information provided by the processing unit 200 to a storage device or a removable recording medium. Otherwise, the control device may control devices other than a device which outputs or records the information provided by the processing unit 200. For example, the control device may control a lighting device to turn on lighting, control TV to turn off an image, control a radio device to adjust volume or control a robot to control movement thereof.

The software, which provides information to an external service, provides information provided from the processing unit 200 to the external service, for example, using an API of the external service. For example, the software may provide information to the server of the external service or application software of a service, which is executed in a client device. The provided information may not necessarily be reflected in the external service immediately and may be provided as, for example, a candidate for being loaded or transmitted to the external service by the user. More specifically, the software may provide, for example, search keywords input by the user or text used as a candidate of a uniform resource locator (URL) in browser software executed in the client device. In addition, the software may load text, images, moving images, sound and the like to the external service such as social media, instead of the user, for example.

An interface 350 is an interface between the processing unit 200 and the output unit 300. For example, when the processing unit 200 and the output unit 300 are implemented as individual devices, the interface 350 may include a wired or wireless communication interface. When at least part of the processing unit 200 and the output unit 300 are implemented as an identical device, the interface 350 may include the aforementioned intra-device interface. Furthermore, when the output unit 300 is implemented by being distributed in a plurality of devices, the interface 350 may include interfaces of different types for the respective devices. For example, the interface 350 may include both a communication interface and an intra-device interface.

### 2. FUNCTIONAL CONFIGURATION OF PROCESSING UNIT

### (2-1. Overall Functional Configuration)

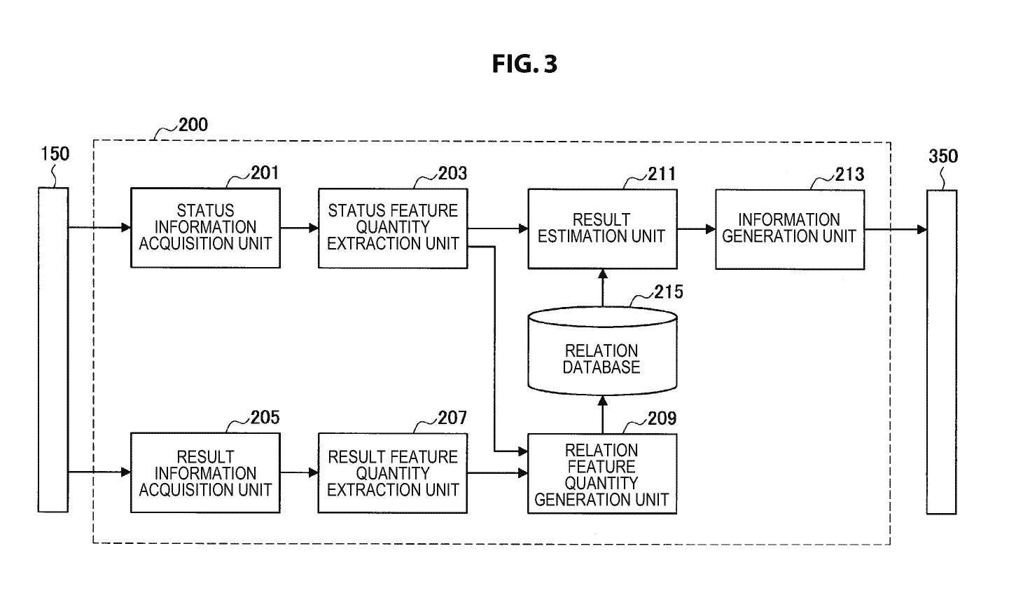

FIG. 3 is a block diagram illustrating an example of functional components of the processing unit according to an embodiment of the present disclosure. Referring to FIG. 3, the processing unit 200 includes a status information acquisition unit 201, a status feature quantity extraction unit 203, a result information acquisition unit 205, a result feature quantity extraction unit 207, a relation feature quantity generation unit 209, a result estimation unit 211 and an information generation unit 213. Hereinafter, each functional component will be described in detail.

The status information acquisition unit 201 acquires various types of information representing situations of the user from the input unit 100 through the interface 150. More specifically, the status information acquisition unit 201 acquires information from a sensor included in the input unit 100, for example. The information acquired from the sensor represents a situation of the user, for example, according to an image of the user, sound, temperature or humidity around the user, perspiration and pulse of the user, motion of the user or the like. The information obtained from the sensor may include information that is not directly sensed by the user, such as position information detected by a GPS receiver. Furthermore, the status information acquisition unit 201 acquires information from the input device included in the input unit 100 or from the software which obtains information from an external service, for example. Information acquired from manipulation input of the user or the external service may represent a mental state of the user, for example, on the basis of frequency of erroneous manipulation or correction of manipulation or the like. In addition, the information acquired from manipulation input of the user or the external service may represent a mental state of the user or a situation in which the user is placed on the service on the basis of text or images input or viewed by the user.

Here, the status information acquisition unit 201 acquires information representing situations of the user in various scenes in the present embodiment. For example, when the user watches TV at home, the status information acquisition unit 201 obtains information representing a scene of watching TV and a situation including a state of the user who is viewing the TV (whether the user is alone or is with someone else, whether the user is laughing or bored, or the like). Furthermore, when the user drives a car, for example, the status information acquisition unit 201 acquires information representing a scene of driving the car (which may include information on the speed and position of the car) and a situation including a state of the user who is driving the car (perspiration, pulse, gaze or the like). In this manner, situations of the user, represented by the information acquired by the status information acquisition unit 201, may include situations of the user in a plurality of different scenes in the present embodiment. Although the status information acquisition unit 201 acquires information from an input means such as the sensor, the input device or software which acquires information from an external service, included in the input unit 100, as described above, different input means may be used for respective scenes.

The status feature quantity extraction unit 203 extracts a feature quantity corresponding to a situation of the user. More specifically, when the status information acquisition unit 201 acquires information from the sensor, for example, the status feature quantity extraction unit 203 extracts a feature quantity by spatially or temporally analyzing the information obtained from the sensor. For example, when the status information acquisition unit 201 acquires information from the input device or the software which obtains information from an external service, the status feature quantity extraction unit 203 extracts a feature quantity by temporally analyzing manipulation input of the user or by performing semantic analysis or image analysis for text or an image input or read by the user. In the case of text, for example, it may be possible to perform semantic analysis using technology such as probabilistic latent semantic analysis (pLSA), latent Dirichlet allocation (LDA) or the like and to extract a feature quantity on the basis of the meaning of the text.

The result information acquisition unit 205 acquires information representing a result generated in the situation processed by the status information acquisition unit 201 and the status feature quantity extraction unit 203. More specifically, the result information acquisition unit 205 may acquire information from an input means such as the sensor, the input device or the software which obtains information from an external service, included in the input unit 100. Here, the information acquired by the result information acquisition unit 205 may be provided by the same input means as that for the status information acquisition unit 201 or by an input means different from the input means for the status information acquisition unit 201, for example.

For example, the result information acquisition unit 205 may acquire information representing a change in the situation of the user, acquired by the status information acquisition unit 201, as information representing a result generated in the situation before change. For example, when the user who is watching TV changes channels, the result information acquisition unit 205 may acquire channel change and a changed channel as information representing a result generated in the state in which the user watches the channel before change. In this case, the information acquired by the result information acquisition unit 205 may be provided by the same input means as that for the status information acquisition unit 201.

Otherwise, the result information acquisition unit 205 may acquire information, which represents a sporadic event occurring in a continuous situation of the user and acquired by the status information acquisition unit 201, as information indicating a result generated in the situation. For example, when the user who is watching TV laughs, laughing may be acquired as information indicating a result generated in the state in which the user is watching TV. In this manner, information indicating a result acquired by the result information acquisition unit 205 may be information of a different type from information indicating a situation and acquired by the status information acquisition unit 201. In this case, the information acquired by the result information acquisition unit 205 may be provided by an input means (e.g., a sensor) different from the input means for the status information acquisition unit 201.

Here, examples of information acquired by the status information acquisition unit 201 and the result information acquisition unit 205 are further described. For example, when the user watches TV at home, the status information acquisition unit 201 may acquire information representing that the user watches TV, that the user is alone and that the user is bored. The result information acquisition unit 205 may acquire information representing that the user changes TV channels and starts to watch a sports program. As another example, when the user drives a car, for example, the status information acquisition unit 201 may acquire information representing that the user drives the car and that perspiration and pulse of the user increase at predetermined rates. Here, the result information acquisition unit 205 may acquire information representing that the user stops the car and runs into a toilet in a rest area.

The result feature quantity extraction unit 207 extracts a feature quantity corresponding to a result generated in the situation processed by the status information acquisition unit 201 and the status feature quantity extraction unit 203. More specifically, when the result information acquisition unit 205 acquires information from the sensor, for example, the result feature quantity extraction unit 207 extracts a feature quantity by spatially or temporally analyzing the information acquired from the sensor. If the result information acquisition unit acquires information from the input device or the software which obtains information from an external service, for example, the result feature quantity extraction unit 207 may extract a feature quantity by temporally analyzing manipulation input of the user or by performing semantic analysis or image analysis for text or an image input or read by the user. In the case of text, for example, it may be possible to perform semantic analysis using technology such as pLSA and LDA and to extract a feature quantity on the basis of the meaning of the text.

The relation feature quantity generation unit 209 generates a relation feature quantity that indicates a relation between a situation of the user and a result generated in the situation on the basis of a status feature quantity extracted by the status feature quantity extraction unit and a result feature quantity extracted by the result feature quantity extraction unit 207. The generated relation feature quantity may be stored in a relation database 215. Details of the relation feature quantity will be described blow along with the four-term analogy model.

The result estimation unit 211 estimates a result that is not generated yet in the situation processed by the status information acquisition unit 201 and the status feature quantity extraction unit 203. As described above, a result processed in the present embodiment is a change in a situation of the user or a sporadic event generated in a continuous situation. Accordingly, when information representing a certain situation is acquired by the status information acquisition unit 201, what kind of result is generated is unknown. Therefore, the result estimation unit 211 estimates whether any result is generated in the current situation and what kind of result is generated on the basis of the status feature quantity extracted by the status feature quantity extraction unit 203 and the relation feature quantity generated by the relation feature quantity generation unit 209. Details of the estimation process of the result estimation unit 211 will be described blow along with the four-term analogy model.

The information generation unit 213 generates information reflecting the result estimated by the result estimation unit 211. For example, when the estimated result is related to an action of the user, the information generation unit 213 generates information including navigation for the action. More specifically, when a result that the user goes to a toilet is estimated in a situation in which the user drives a car, for example, the information generation unit 213 generates a message for inducing the user to take a rest and information on the location of a neighboring rest area. In addition, when a result that the user changes channels and starts to watch a sports game is estimated in a situation in which the user watches TV, for example, the information generation unit 213 generates information for presenting the sports program as a candidate of channel change. The information generated by the information generation unit 213 is provided to the output unit 300 through the interface 350 and output by the output unit 300.

More specifically, the information generated by the information generation unit 213 may be output, for example, according to an image, sound, vibration or the like from an output device included in the output unit 300, such as a display, a speaker, a vibrator or the like. Furthermore, the information generated by the information generation unit 213 may be output as a printed matter from a printer controlled by a control device included in the output unit 300 or recorded as electronic data in a storage device or a removable recording medium. Otherwise, the information generated by the information generation unit 213 may be used for control of an apparatus by the control device included in the output unit 300. In addition, the information generated by the information generation unit 213 may be provided to an external service through software which is included in the output unit 300 and provides information to the external service.

### (2-2. Details of Processing Using Four-Term Analogy Model)

In the present embodiment, processing using the four-term analogy model is performed in the relation feature quantity generation unit 209 and the result estimation unit 211. Hereinafter, such processing will be described in more detail.

Four-term analogy is a model for estimating an item X that satisfies a relation R with respect to a new item C when an item A, an item B and the relation R between the item A and the item B are given as premise knowledge. More specifically, when “fish” is given as the item A and “scale” is given as the item B, for example, the relation R may be a concept similar to “have” and “cover”. Here, when “bird” is given as the new item C, it may be possible to estimate “feather”, “wing” and the like as the item X that satisfies the relation R included in the premise knowledge.

Such four-term analogy may also be referred to as mapping the structure of the item A, item B and relation R constituting the premise knowledge in a knowledge domain (base domain) to a knowledge domain (target domain) to which the new item C belongs. Such structure mapping theory is described in D. Gentner, “Structure-Mapping: A Theoretical Frame work for Analogy”, Cognitive Science, 1983, etc., for example. In addition, technology for systemizing the concept of four-term analogy from the viewpoint of the fuzzy theory has also been proposed and described in, for example, Yosuke Kaneko, Kazuhiro Okada, Shinichiro Ito, Takuya Nomura and Tomohiro Takagi, “A Proposal of Analogical Reasoning Based on Structural Mapping and Image Schemas”, 5^{th} International Conference on Soft Computing and Intelligent Systems and 11th International Symposium on Advanced Intelligent Systems (SCIS & ISIS 10), 2010, etc. Furthermore, a method of multi-dimensionalizing the four-term analogy is described in JP 2012-159983A, etc.

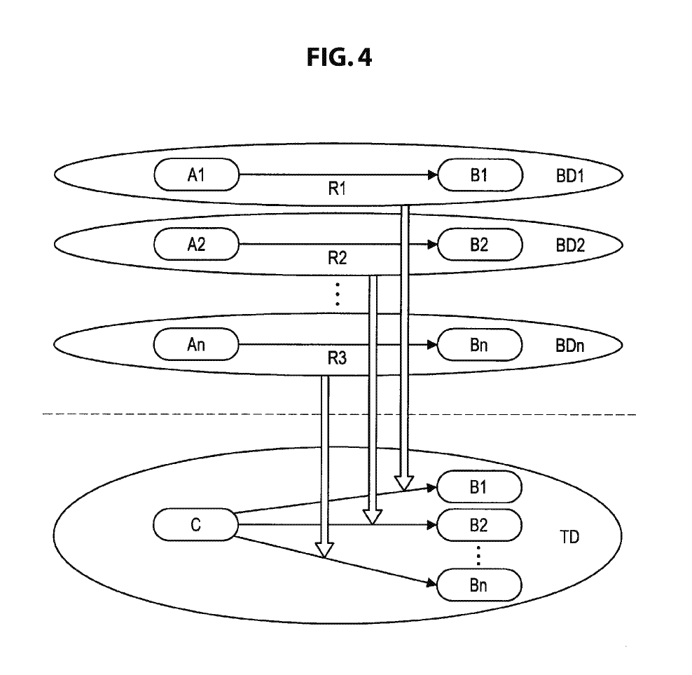

FIG. 4 is an explanatory diagram of a process using the four-term analogy in an embodiment of the present disclosure. More specifically, in the present embodiment, when the status information acquisition unit 201 acquires information representing a situation and the result information acquisition unit 205 acquires information indicating a result generated in the situation, the situation and the result are respectively processed as an item A and an item B. In this case, a relation feature quantity generated by the relation feature quantity generation unit 209 on the basis of a feature quantity extracted by the status feature quantity extraction unit 203 and a feature quantity extracted by the result feature quantity extraction unit 207 is processed as a feature quantity indicating a relation R. That is, the item A, item B and relation R in a base domain BD may be defined by a set of the situation, result and relation feature quantity.

When the status information acquisition unit 201 acquires information representing a situation whereas the result information acquisition unit 205 does not acquire information indicating a result generated in the situation, the acquired situation is processed as a new item C. In this case, the result estimation unit 211 estimates a result on the basis of a feature quantity extracted by the status feature quantity extraction unit 203 and a relation feature quantity generated by the relation feature quantity generation unit 209 based on a different situation and result. That is, in this case, the result estimation unit 211 may predict an item X corresponding to the item C, that is, a result that is not generated yet in a new situation by mapping the item A, item B and relation R in the base domain BD, which are defined by the relation feature quantity, to a target domain TD to which the item C belongs. To represent the item X as a feature quantity, like the items A to C and relation R, the result estimation unit 211 converts the feature quantity indicating the item X into a detailed result.

Here, a plurality of base domains BD may be defined, as illustrated in FIG. 4. More specifically, when the result information acquisition unit 205 acquires information indicating results and the relation feature quantity generation unit 209 generates relation feature quantities in n number of situations represented by information acquired by the status information acquisition unit 201, items A1, A2, . . . , An, items B1, B2, . . . , Bn and relations R1, R2, . . . , Rn are defined in n number of base domains BD1, BD2, . . . , BDn. By mapping a relationship among an item Ak, an item Bk and a relation Rk (k=1, 2, . . . , n) in a base domain BDk to the target domain TD, n number of items X (X1, X2, . . . , Xn) corresponding to the new item C are predicted. In this case, the result estimation unit 211 may estimate a plurality of results.

### 3. PROCESSING FLOW

### (3-1. Definition of Relation Between Situation and Result)

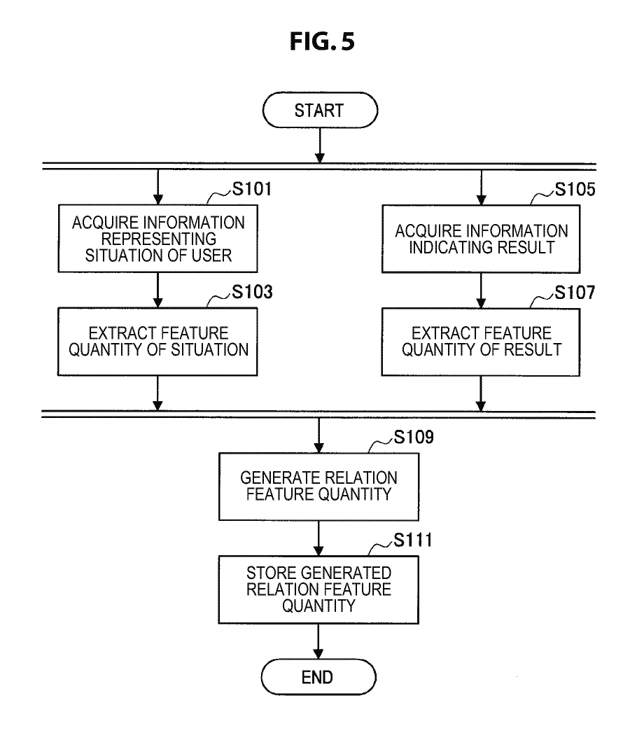

FIG. 5 is a flowchart illustrating an example of a process of defining a relation between a situation and a result in an embodiment of the present disclosure. Referring to FIG. 5, the status information acquisition unit 201 acquires information representing a situation of the user first (S101). As described above, the status information acquisition unit 201 acquires information from an input means such as a sensor, an input device, software or the like included in the input unit 100. When the status information acquisition unit 201 acquires information from a plurality of input means, timing of information acquisition from the input means may have variance.

Thereafter, the status feature quantity extraction unit 203 extracts a feature quantity of the situation (S103). As described above, the status feature quantity extraction unit 203 extracts the feature quantity by spatially or temporally analyzing the information acquired by the status information acquisition unit 201 or by performing semantic analysis or image analysis for text or an image. For example, when the information acquired by the status information acquisition unit 201 changes, the status feature quantity extraction unit 203 re-extracts a feature quantity. Otherwise, the status information acquisition unit 201 may re-extract a feature quantity at predetermined intervals.

The result information acquisition unit 205 acquires information indicating a result generated in the aforementioned situation simultaneously with the processes of S101 and S103, or before or after the processes of S101 and S103 (S105). As described above, the result information acquisition unit 205 acquires information from an input means such as the sensor, input device, software or the like included in the input unit 100. The result defined in the present embodiment may be associated with a specific time, such as situation change or a sporadic event generated in a continuous situation. Accordingly, when the result information acquisition unit 205 acquires information from a plurality of input means, information from each input means at the time may be acquired as information indicating the result.

Thereafter, the result feature quantity extraction unit 207 extracts a feature quantity of the result (S107). The result feature quantity extraction unit 207 extracts the feature quantity by spatially or temporally analyzing the information acquired by the result information acquisition unit 205 or by performing semantic analysis or image analysis for text or an image, like the status feature quantity extraction unit 203. As described above, the result information acquisition unit 205 may acquire information from an input means at a specific time. Accordingly, when the result information acquisition unit 205 acquires information, that is, any result is generated, the result feature quantity extraction unit 207 may extract a feature quantity of the result on the basis of the information acquired by the result information acquisition unit 205.

When the feature quantities of the situation and the result are extracted through the processes of S103 and S107, the relation feature quantity generation unit 209 generates a relation feature quantity (S109) and stores the generated relation feature quantity in the relation database 215 (S111). As described above, the generated relation feature quantity corresponds to the relation R between the item A (situation) and the item B (result) in the base domain BD in the four-term analogy model.

### (3-2. Estimation of Result)

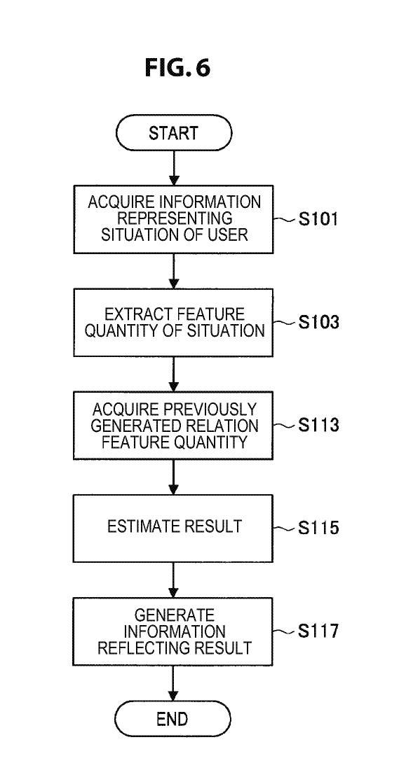

FIG. 6 illustrates a flowchart illustrating an example of a process of estimating a result in an embodiment of the present disclosure. Referring to FIG. 6, the status information acquisition unit 201 acquires information representing a situation of the user first (S101) and the status feature quantity extraction unit 203 extracts a feature quantity of the situation (S103). These processes are the same as the aforementioned processes described with reference to FIG. 5.

When the feature quantity of the situation is extracted through the processes of S101 and S103 whereas a feature quantity of a result is not extracted (information indicating a result is not acquired), the result estimation unit 211 acquires a previously generated relation feature quantity from the relation database 215 (S113) and estimates a result in the situation acquired in S101 on the basis of the feature quantity of the situation and the relation feature quantity (S115). When the result is estimated, the information generation unit 213 generates information in which the result has been reflected (S117). In S115, the result estimation unit 211 may estimate that a result worth generating information is not generated. In such a case, the process of generating information in S117 may not be performed.

### 4. DETAILED APPLICATION EXAMPLES

Hereinafter, more detailed application examples of the present embodiment will be described along with a combination of a state and a result.

### 4-1. First Example

In a first example, the input unit 100 is realized in a mobile/wearable device carried by or mounted on the user, for example. Otherwise, the input unit 100 is realized in terminal devices installed in at least two different places such as the house, office and car of the user. Information representing situations of the user in different scenes is acquired according to the input unit 100. In addition, the output unit 300 may be realized in the same mobile/wearable device or terminal device as those for the input unit 100.

In the aforementioned example, it is assumed that information representing that a keyboard or mouse operation is hurried is acquired by the status information acquisition unit 201 when the user works in the office, for example. In this situation, it is assumed that information representing that the user leaves the seat and have a rest or goes to a toilet (user disappears from an image of surroundings of a desk, a motion sensor of a mobile/wearable device detects leaving of the user or the like) is acquired by the result information acquisition unit 205. In this case, a feature quantity extracted according to the status feature quantity extraction unit 203 may indicate “an unstable state of the user”. In addition, a feature quantity extracted by the result feature quantity extraction unit 207 may indicate a result that “the user leaves a regular position and have a rest”.

The relation feature quantity generation unit 209 generates a relation feature quantity indicating that “the user needs to leave the regular position and take a rest” when “the user does not feel at ease” from the feature quantities of the situation and the result and stores the relation feature quantity in the relation database 215. Although the relation feature quantity is described by being assigned a text label in the present embodiment, the label is not necessarily needed and the feature quantity may be processed as an abstract feature quantity.

At other times, it is assumed that information representing that perspiration and pulse of the user increase is acquired by the status information acquisition unit 201 when the user is in a car. In this case, the result estimation unit 211 estimates that “the user leaves the regular position and takes a rest” is generated as a result on the basis of the feature quantity (which may be a feature quantity indicating “unstable state of the user”) extracted by the status feature quantity extraction unit 203 and the aforementioned relation feature quantity acquired from the relation database 215. The information generation unit 213 receives the estimated result and generates a message for inducing the user to take a rest and information about the location of a neighboring rest area, and this information is output as images and sound from a car navigation system, for example.

As in the aforementioned first example, the result estimation unit 211 may predict a second result (the user stops the car and takes a rest) generated in a second situation (the user is driving the car) occurring in a scene different from a first situation (the user is working) on the basis of a first result (the user leaves the seat and takes a rest) generated in the first situation in the present embodiment.

### 4-2. Second Example

In the second example, the input unit 100 is realized, for example, in a terminal device (personal computer, mobile/wearable device or the like) used for the user to browse websites. Information representing situations of the user in different scenes is acquired in this input unit 100. In addition, the output unit 300 is realized, for example, in the same terminal device as that for the input unit 100.

In the aforementioned example, it is assumed that information representing that the user browses websites related to a personal computer (PC), for example, is acquired by the status information acquisition unit 201. In this situation, it is assumed that a browsing log indicating that the user checks vendors of parts of the PC or accesses online stores of the parts of the PC is acquired by the result information acquisition unit 205. In this case, a feature quantity extracted by the status feature quantity extraction unit 203 may indicate that “the user intends to perform a consumption behavior”. In addition, a feature quantity extracted by the result feature quantity extraction unit 207 may indicate a result that “the user has found parts for self-making desired one”.

The relation feature quantity generation unit 209 generates a relation feature quantity indicating that “the user finds parts for self-making desired one” is needed when “the user intends to perform a consumption behavior” from the aforementioned situation and result and stores the generated relation feature quantity in the relation database 215. The label of the relation feature quantity is not necessarily needed as in the aforementioned first example.

At other times, it is assumed that information representing that the user browses websites related to traveling is acquired by the status information acquisition unit 201. In this case, the result estimation unit 211 estimates that “the user finds parts for self-making desired one” is generated as a result on the basis of the feature quantity (which may be a feature quantity indicating that “the user intends to perform a consumption behavior”) extracted by the status feature quantity extraction unit 203 and the aforementioned relation feature quantity acquired from the relation database 215. The information generation unit 213 receives the estimated result and generates information presenting portal sites such as sightseeing spots and hotels as websites recommended for the user, and this information is output as images through a display, for example.

As in the aforementioned second example, the result estimation unit 211 may predict a second result (the user searches travel destinations and places to stay) generated in a second situation (the user performs browsing associated with traveling) occurring in a scene different from a first situation (the user performs browsing associated with the PC) on the basis of a first result (the user searches parts of the PC) generated in the first situation in the present embodiment.

A reverse example may be possible. That is, the result estimation unit 211 may predict a result that the user checks vacation tour (which is a contrast to the aforementioned second result) generated during browsing associated with traveling (second situation) on the basis of a result that the user checks PCs of finished products (which is a contrast to the aforementioned first result), which is generated during browsing associated with PCs (first situation).

### 4-3. Third Example

In a third example, the input unit 100 is realized by a mobile/wearable device carried by or mounted on the user, for example. Otherwise, the input unit 100 may be implemented by a refrigerator or an air-conditioner (having an information processing function and a network communication function) installed in the house of the user. According to the input unit 100, information representing situations of the user in different scenes is acquired. In addition, the output unit 300 may be implemented by the same device as that with respect to the input unit 100 (the same device as that for the input unit 100 or a device different from the device for the input unit 100 from among the aforementioned various devices), for example.

In the aforementioned example, it is assumed that information representing that the user performs a setting operation of the refrigerator is acquired by the status information acquisition unit 201, for example. In this situation, it is assumed that an operation log indicating that the user increases a set temperature of the refrigerator (weakens cooling performance of the refrigerator) is acquired by the result information acquisition unit 205. In this case, a feature quantity extracted by the status feature quantity extraction unit 203 may indicate that “the user has performed a behavior affecting energy consumption”. In addition, a feature quantity extracted by the result feature quantity extraction unit 207 may indicate a result that “energy consumption has decreased”.

The relation feature quantity generation unit 209 generates a relation feature quantity indicating that the user is ecology-conscious from the feature quantities of the situation and result and stores the relation feature quantity in the relation database 215. A label for the relation feature quantity is not necessarily needed as in the aforementioned first and second examples.

At other times, it is assumed that information representing that the user goes out for shopping is acquired by the status information acquisition unit 201. There are several options of supermarkets for shopping and the options include stores that distribute disposable shopping bags and stores that do not distribute disposable shopping bags. Under this premise, a feature quantity extracted by the status feature quantity extraction unit 203 from the information acquired by the status information acquisition unit 201 in the aforementioned case may indicate that “the user has performed a behavior affecting energy consumption”. The result estimation unit estimates that “more ecology-conscious behavior” is generated as a result on the basis of the feature quantity and the aforementioned relation feature quantity obtained from the relation database 215. The information generation unit 213 receives the estimated result and generates information presenting advertisements about stores that do not distribute disposable shopping bags, and this information is output as images through a display or output as sound through a speaker, for example.

As in the aforementioned third example, the result estimation unit 211 may predict a second result (the user visits a store that does not distribute disposable shopping bags) generated in a second situation (the user goes out for shopping) occurring in a scene different from a first situation (the user performs a setting operation of the refrigerator) on the basis of a first result (the user has increased the set temperature of the refrigerator) generated in the first situation in the present embodiment.

As another example, the input unit 100 may be implemented according to a terminal device which is installed in a supermarket and detect coming to the store and the output unit 300 may be implemented according to a refrigerator installed in the house of the user. In this case, the result estimation unit 211 may predict a result that the user increases the set temperature of the refrigerator (second result), which is generated when the user performs a setting operation of the refrigerator (second situation), on the basis of a result that the user visits a store that does not distribute disposable shopping bags (first result), which is generated when the user goes out for shopping (first situation).

As a similar example, when the second situation is a situation in which the user tries to move along the street, the result estimation unit 211 may predict a second result that the user likes to walk a moderate distance and output navigation information for walking a moderate distance while reducing a distance moved by electric railcars or buses.

### 5. SYSTEM CONFIGURATION

One embodiment of the present disclosure has been described above. As described above, the system 10 according to the present embodiment includes the input unit 100, the processing unit 200 and the output unit 300 and these components are realized by one or more information processing apparatuses. Hereinafter, more detailed examples of combinations of information processing apparatuses that implement the system 10 will be described.

### First Example

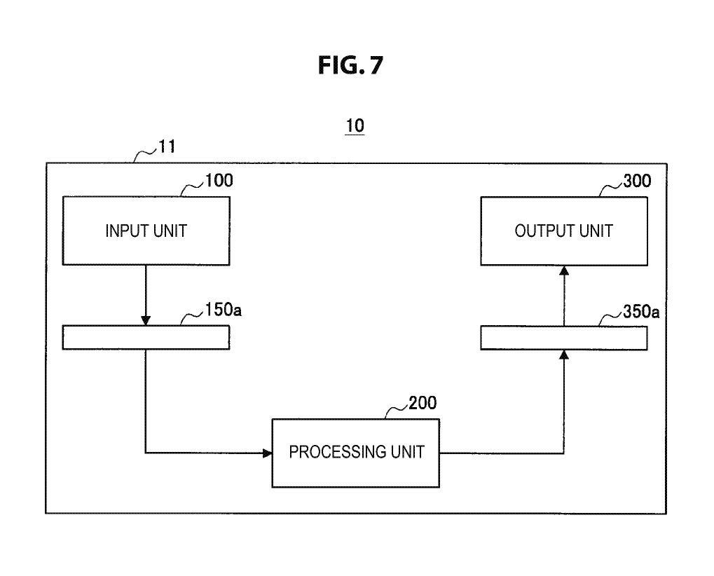

FIG. 7 is a block diagram illustrating a first example of a system configuration according to an embodiment of the present disclosure. Referring to FIG. 7, the system 10 includes an information processing apparatus 11. Any of the input unit 100, the processing unit 200 and the output unit 300 is realized in the information processing apparatus 11. The information processing apparatus 11 may be a terminal device or a server as described below. In the first example, the information processing apparatus 11 may be a standalone apparatus which does not communicate with an external device via a network in order to implement functions according to the embodiment of the present disclosure. The information processing apparatus 11 may communicate with an external device for other functions and thus may not necessarily be a standalone apparatus. Any of an interface 150a between the input unit 100 and the processing unit 200 and an interface 350a between the processing unit 200 and the output unit 300 may be an intra-device interface.

In the first example, the information processing apparatus 11 may be a terminal device, for example. In this case, the input unit 100 may include an input device, a sensor, software which acquires information from external services and the like. The software which acquires information from external services obtains data from, for example, application software of services, which is executed in the terminal device. The processing unit 200 is implemented by operation of a processor or a processing circuit included in the terminal device according to a program stored in a memory or a storage device. The output unit 300 may include an output device, a control device, software which provides information to external services and the like. The software which provides information to external services may provide information to, for example, application software of services, which is executed in the terminal device.

Otherwise, the information processing apparatus 11 may be a server in the first example. In this case, the input unit 100 may include software which acquires information from external services. The software which acquires information from external services obtains data from, for example, servers of the external services (the information processing apparatus 11 itself may be possible). The processing unit 200 is implemented by operation of a processor included in a terminal device according to a program stored in a memory or a storage device. The output unit 300 may include software which provides information to external services. The software which provides information to external services provides information to, for example, servers of the external services (the information processing apparatus 11 itself may be possible).

### Second Example

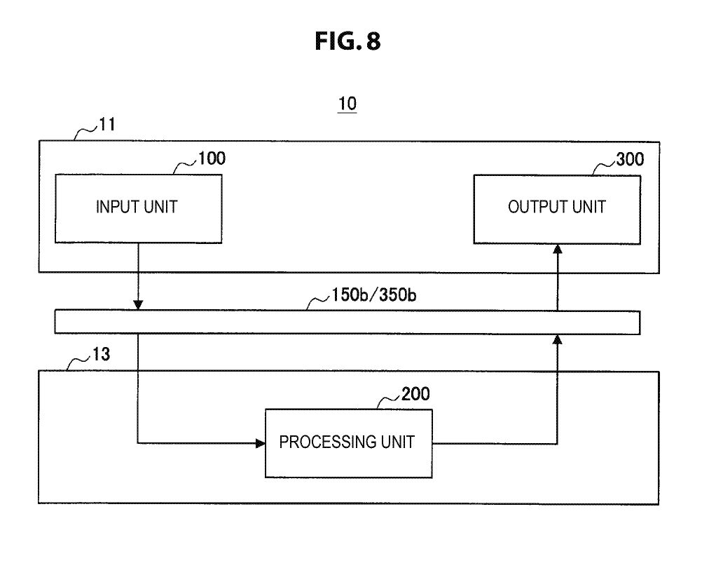

FIG. 8 is a block diagram illustrating a second example of the system configuration according to an embodiment of the present disclosure. Referring to FIG. 8, the system 10 includes information processing apparatuses 11 and 13. The input unit 100 and the output unit 300 are realized in the information processing apparatus 11 whereas the processing unit 200 is realized in the information processing apparatus 13. The information processing apparatus 11 communicates with the information processing apparatus 13 via a network in order to implement functions according to the embodiment of the present disclosure. Any of an interface 150b between the input unit 100 and the processing unit 200 and an interface 350b between the processing unit 200 and the output unit 300 may be a communication interface between apparatuses.

In the second example, the information processing apparatus 11 may be a terminal device, for example. In this case, the input unit 100 may include an input device, a sensor, software which acquires information from external services and the like as in the aforementioned first example. The output unit 300 may include an output device, a control device, software which provides information to external services and the like as in the aforementioned first example. Otherwise, the information processing apparatus 11 may be a server for exchanging information with external services. In this case, the input unit 100 may include software which acquires information from the external services. The output unit 300 may include software which provides information to external services.

In the second example, the information processing apparatus 13 may be a server or a terminal device. The processing unit 200 is implemented by operation of a processor or a processing circuit included in the information processing apparatus 13 according to a program stored in a memory or a storage device. The information processing apparatus 13 may be an apparatus dedicated as a server, for example. In this case, the information processing apparatus 13 may be installed in a data center and the like or at home. Otherwise, the information processing apparatus 13 may be an apparatus that may be used as a terminal device for other functions but does not implement the input unit 100 and the output unit 300 with respect to functions according to the embodiment of the present disclosure. In the following examples, the information processing apparatus 13 may be a server or a terminal device in the aforementioned sense.

As an example, a case in which the information processing apparatus 11 is a wearable device and the information processing apparatus 13 is a mobile device connected with the wearable device through Bluetooth (registered trademark) or the like is considered. When the wearable device receives manipulation input by the user (input unit 100), the mobile device performs processing on the basis of a request transmitted based on the manipulation input (processing unit 200) and a processing result is output from the wearable device (output unit 300), it may be said that the wearable device functions as the information processing apparatus 11 and the mobile device functions as the information processing apparatus 13.

### Third Example

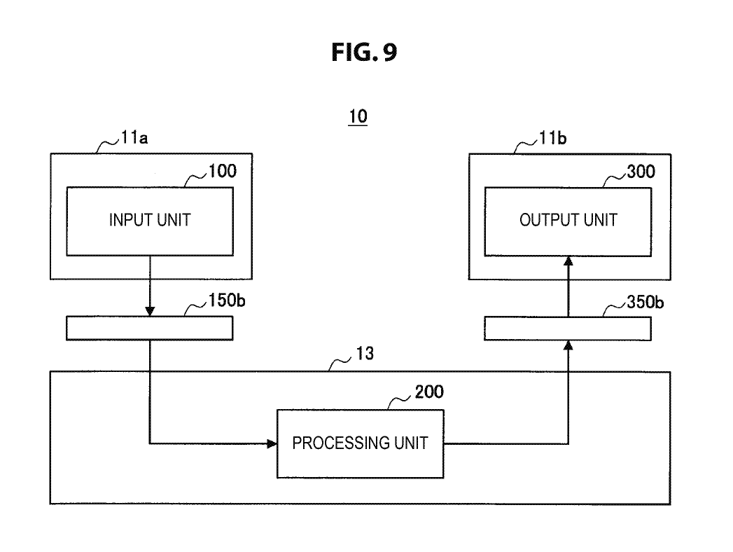

FIG. 9 is a block diagram illustrating a third example of the system configuration of an embodiment of the present disclosure. Referring to FIG. 9, the system 10 includes information processing apparatuses 11a, 11b and 13. The input unit 100 is realized in the information processing apparatus 11a. The output unit 300 is realized in the information processing apparatus 11b. The processing unit 200 is realized in the information processing apparatus 13. The information processing apparatuses 11a and 11b respectively communicate with the information processing apparatus 13 via a network in order to implement functions according to the embodiment of the present disclosure. Any of an interface 150b between the input unit 100 and the processing unit 200 and an interface 350b between the processing unit 200 and the output unit 300 may be a communication interface between apparatuses. In the third example, however, the interfaces 150b and 350b may include different types of interfaces since the information processing apparatus 11a and the information processing apparatus 11b are separate apparatuses.

In the third example, the information processing apparatuses 11a and 11b may be terminal devices, for example. In this case, the input unit 100 may include an input device, a sensor, software which acquires information from external service and the like as in the aforementioned first example. The output unit 300 may include an output device, a control device, software which provides information to external service and the like as in the aforementioned first example. Otherwise, one or both of the information processing apparatuses 11a and 11b may be servers for acquiring information from external services and providing information to the external services. In this case, the input unit 100 may include software which acquires information from external services. In addition, the output unit 300 may include software which provides information to the external services.

In the third example, the information processing apparatus 13 may be a server or a terminal device as in the aforementioned second example. The processing unit 200 is implemented by operation of a processor or a processing circuit included in the information processing apparatus 13 according to a program stored in a memory or a storage device.

In the aforementioned second example, the information processing apparatus 11a which realizes the input unit 100 and the information processing apparatus 11b which realizes the output unit 300 are separate apparatuses. Accordingly, it may be possible to realize a function of outputting a result of processing based on an input acquired by the information processing apparatus 11a corresponding to a terminal device carried or used by a first user from the information processing apparatus 11b corresponding to a terminal device carried or used by a second user different from the first user. In addition, it may be possible to realize a function of outputting a result of processing based on an input acquired by the information processing apparatus 11a corresponding to the terminal device carried or used by the first user from the information processing apparatus 11b corresponding to a terminal device which is not present around the first user at that time (e.g., which is installed in the house from which the user is away). Otherwise, the information processing apparatus 11a and the information processing apparatus 11b may be a terminal device that is carried or used by the same user. For example, when the information processing apparatuses 11a and 11b are wearable devices mounted on different portions of a user or correspond to a combination of a wearable device and a mobile device, a function of connecting the devices may be provided to the user.

### Fourth Example

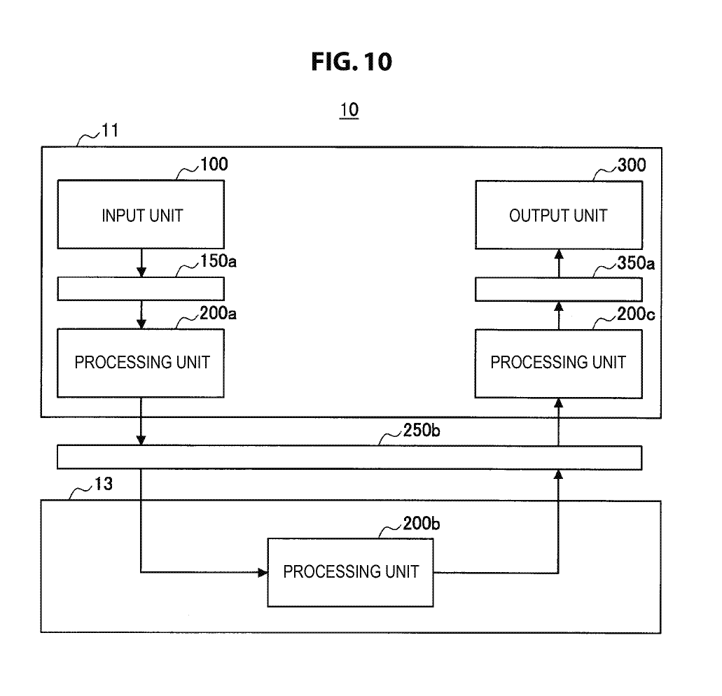

FIG. 10 is a block diagram illustrating a fourth example of the system configuration of an embodiment of the present disclosure. Referring to FIG. 10, the system 10 includes information processing apparatuses 11 and 13. In the fourth example, the input unit 100 and the output unit 300 are realized in the information processing apparatus 11, whereas the processing unit 200 is realized by being distributed in the information processing apparatuses 11 and 13. The information processing apparatus 11 communicates with the information processing apparatus 13 via a network in order to implement functions according to the embodiment of the present disclosure.

As described above, the processing unit 200 is realized by being distributed in the information processing apparatuses 11 and 13 in the fourth example. More specifically, the processing unit 200 includes processing units 200a and 200c realized in the information processing apparatus 11 and a processing unit 200b realized in the information processing apparatus 13. The processing unit 200a performs processing on the basis of information provided from the input unit 100 through an interface 150a and provides a processing result to the processing unit 200b. In this sense, it may be said that the processing unit 200a performs pre-processing. The processing unit 200c performs processing on the basis of information provided by the processing unit 200b and provides a processing result to the output unit 300 through an interface 350a. In this sense, it may be said that the processing unit 200c performs post-processing.

Although both the processing unit 200a which performs pre-processing and the processing unit 200c which performs post-processing are shown in the illustrated example, only one of the processing units may be present actually. That is, the information processing apparatus 11 realizes the processing unit 200a which performs pre-processing but does not realize the processing unit 200c which performs post-processing, and information provided by the processing unit 200b may be directly provided to the output unit 300. Likewise, the information processing apparatus 11 may realize the processing unit 200c which performs post-processing without realizing the processing unit 200a which performs pre-processing.

Interfaces 250b are respectively interposed between the processing unit 200a and the processing unit 200b and between the processing unit 200b and the processing unit 200c. The interfaces 250b are communication interfaces between apparatuses. When the information processing apparatus 11 realizes the processing unit 200a, the interface 150a is an intra-device interface. Likewise, when the information processing apparatus 11 realizes the processing unit 200c, the interface 350a is an intra-device interface.

The aforementioned fourth example is the same as the aforementioned second example except that one or both of the processing unit 200a and the processing unit 200c are implemented by processors or processing circuits included in the information processing apparatus 11. That is, the information processing apparatus 11 may be a server for exchanging information with terminal devices or external services. In addition, the information processing apparatus 13 may be a server or a terminal device.

### Fifth Example

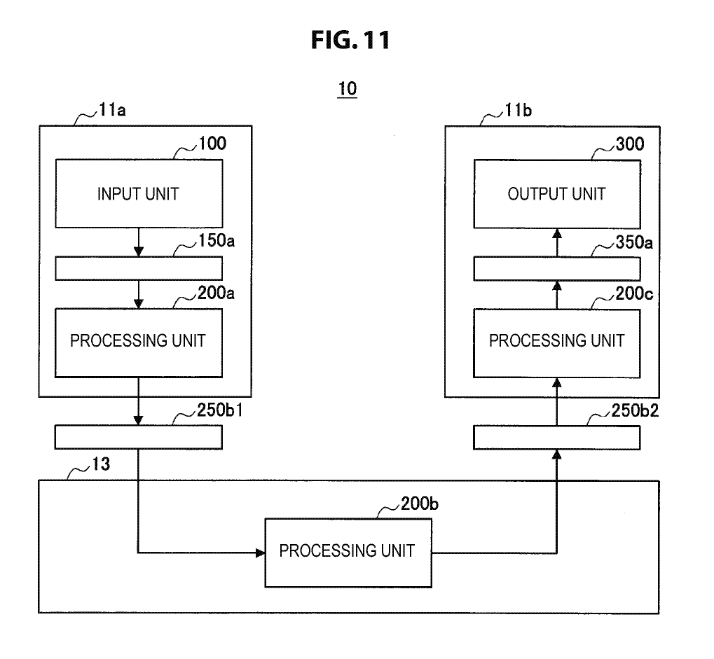

FIG. 11 is a block diagram illustrating a fifth example of the system configuration of an embodiment of the present disclosure. Referring to FIG. 11, the system 10 includes information processing apparatuses 11a, 11b and 13. In the fifth example, the input unit 100 is realized in the information processing apparatus 11a and the output unit 300 is realized in the information processing apparatus 11b. The processing unit 200 is realized by being distributed in the information processing apparatuses 11a 11b and 13. The information processing apparatuses 11a and 11b respectively communicate with the information processing apparatus 13 via a network in order to implement functions according to the embodiment of the present disclosure.

As illustrated, the processing unit 200 is realized by being distributed in the information processing apparatuses 11a 11b and 13 in the fifth example. More specifically, the processing unit 200 includes a processing unit 200a realized in the information processing apparatus 11a, a processing unit 200b realized in the information processing apparatus 13 and a processing unit 200c realized in the information processing apparatus 11b. Distribution of the processing unit 200 is as in the aforementioned fourth example. In the fifth example, however, interfaces 250b1 and 250b2 may respectively include different types of interfaces since the information processing apparatus 11a and the information processing apparatus 11b are separate apparatuses.

The fifth example is the same as the aforementioned third example except that one or both of the processing unit 200a and the processing unit 200c are implemented by processors or processing circuits included in the information processing apparatus 11a or 11b. That is, the information processing apparatuses 11a and 11b may be servers for exchanging information with terminal devices or external services. In addition, the information processing apparatus 13 may be a server or a terminal device. Furthermore, although the processing unit is omitted in a terminal or a server including the input unit and the output unit in the following examples, any or all of apparatuses may include the processing unit in any example.

### (Example of Client-Server System)

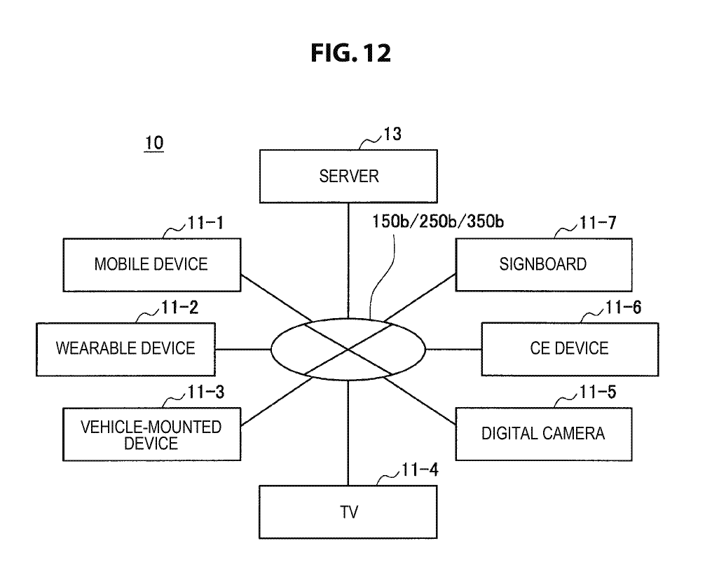

FIG. 12 is a diagram illustrating a client-server system as a detailed example of the system configuration according to an embodiment of the present disclosure. In the illustrated example, the information processing apparatus 11 (or information processing apparatuses 11a and 11b) is a terminal device and the information processing apparatus 13 is a server.

As illustrated, the terminal device may include a mobile device 11-1 such as a smartphone, a tablet or a notebook personal computer (PC), a wearable device 11-2 such as an eyewear or contact lens type terminal, a wrist watch type terminal, a bracelet type terminal, a ring type terminal, a headset, a clothing-mounted or clothing-integrated terminal, a shoe-mounted or shoe-integrated terminal or a necklace type terminal, a vehicle-mounted device 11-3 such as a car navigation system or a rear seat entertainment system, a TV 11-4, a digital camera 11-5, a consumer electronics (CE) device 11-6 such as a recorder, a game machine, an air-conditioner, a refrigerator, a washing machine or a desk top PC, a robot device, a device including a sensor provided to equipment or the like, a digital signboard 11-7 installed on the streets, etc., for example. The information processing apparatus 11 (terminal device) communicates with the information processing apparatus 13 (server) via a network. The network between the terminal device and the server corresponds to the interface 150b, the interface 250b or the interface 350b in the aforementioned examples. Such apparatuses may individually perform connecting operation therebetween, and a system in which all apparatuses may perform connecting operation may be constructed.

The example of FIG. 12 is illustrated to aid in easily understanding an example of implementing the system 10 as a client-server system, and the system 10 is not limited to the client-server system as described in the aforementioned examples. That is, both the information processing apparatuses 11 and 13 may be terminal devices and both the information processing apparatuses 11 and 13 may be servers, for example. When the information processing apparatus 11 includes the information processing apparatuses 11a and 11b, one of the information processing apparatuses 11a and 11b may be a terminal device and the other may be a server. When the information processing apparatus 11 is a terminal device, examples of the terminal device are not limited to the aforementioned terminal devices 11-1 to 11-7 and may include terminal devices of other types.

### Sixth Example

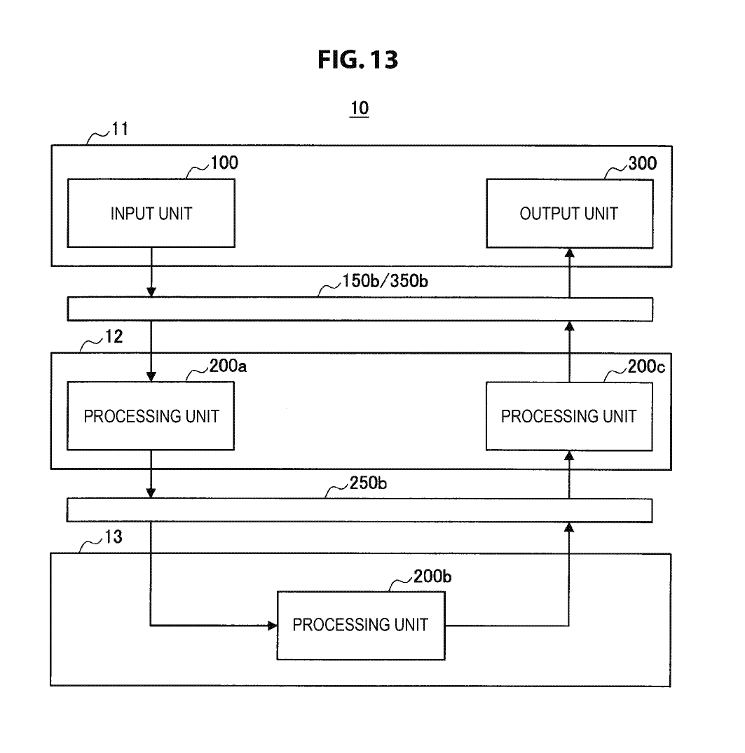

FIG. 13 is a block diagram illustrating a sixth example of the system configuration of an embodiment of the present disclosure. Referring to FIG. 13, the system 10 includes information processing apparatuses 11, 12 and 13. The input unit 100 and the output unit 300 are realized in the information processing apparatus 11, whereas the processing unit 200 is realized by being distributed in the information processing apparatuses 12 and 13. The information processing apparatuses 11 and 12 respectively communicate with the information processing apparatuses 12 and 13 via a network in order to implement functions according to the embodiment of the present disclosure.

As described above, the processing unit 200 is realized by being distributed in the information processing apparatuses 12 and 13 in the sixth example. More specifically, the processing unit 200 includes processing units 200a and 200c realized in the information processing apparatus 12 and a processing unit 200b realized in the information processing apparatus 13. The processing unit 200a performs processing on the basis of information provided from the input unit 100 through an interface 150b and provides a processing result to the processing unit 200b through an interface 250b. The processing unit 200c performs processing on the basis of information provided from the processing unit 200b through the interface 250b and provides a processing result to the output unit 300 through an interface 350b. Although both the processing unit 200a which performs pre-processing and the processing unit 200c which performs post-processing are illustrated in the example, only one of the processing units 200a and 200c may be present actually.

In the sixth example, the information processing apparatus 12 is interposed between the information processing apparatus 11 and the information processing apparatus 13. More specifically, the information processing apparatus 12 may be, for example, a terminal device or a server interposed between the information processing apparatus 11 corresponding to a terminal device and the information processing apparatus 13 corresponding to a server. As an example in which the information processing apparatus 12 is a terminal device, there is a case in which the information processing apparatus 11 is a wearable device, the information processing apparatus 12 is a mobile device connected with the wearable device through Bluetooth (registered trademark) or the like, and the information processing apparatus 13 is a server connected with the mobile device through the Internet. As an example in which the information processing apparatus 12 is a server, there is a case in which the information processing apparatus 11 is a terminal device, the information processing apparatus 12 is an intermediate server connected with the terminal device through a network and the information processing apparatus 13 is a server connected with the intermediate server through a network.

### Seventh Example

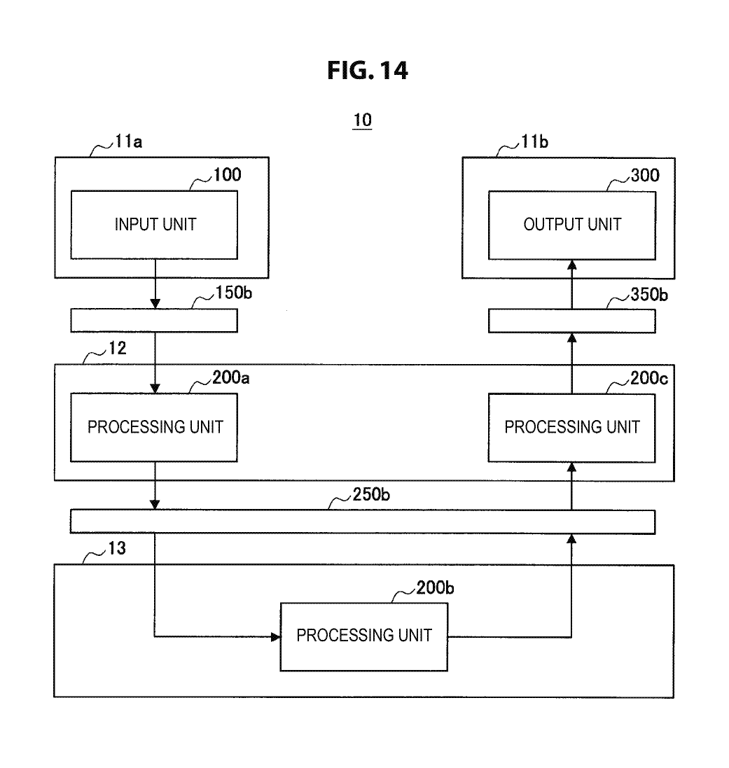

FIG. 14 is a block diagram illustrating a seventh example of the system configuration of an embodiment of the present disclosure. Referring to FIG. 14, the system 10 includes information processing apparatuses 11a, 11b, 12 and 13. In the illustrated example, the input unit 100 is realized in the information processing apparatus 11a and the output unit 300 is realized in the information processing apparatus 11b. The processing unit 200 is realized by being distributed in the information processing apparatuses 12 and 13. The information processing apparatuses 11a and 11b communicate with the information processing apparatus 12 and the information processing apparatus 12 communicates with the information processing apparatus 13 via a network in order to implement functions according to the embodiment of the present disclosure.

The seventh example corresponds to a combination of the aforementioned third example and sixth example. That is, the information processing apparatus 11a realizing the input unit 100 and the information processing apparatus 11b realizing the output unit 300 are separate apparatuses in the seventh example. More specifically, the seventh example includes a case in which the information processing apparatuses 11a and 11b are wearable devices mounted on different portions of a user, the information processing apparatus 12 is a mobile terminal connected with the wearable devices through Bluetooth (registered trademark) or the like and the information processing apparatus 13 is a server connected with the mobile device through the Internet. In addition, the seventh example also includes a case in which the information processing apparatuses 11a and 11b are terminal devices (which may be carried or used by the same user or different users), the information processing apparatus 12 is an intermediate server connected with the terminal devices through a network and the information processing apparatus 13 is a server connected with the intermediate server through a network.

### Eighth Example

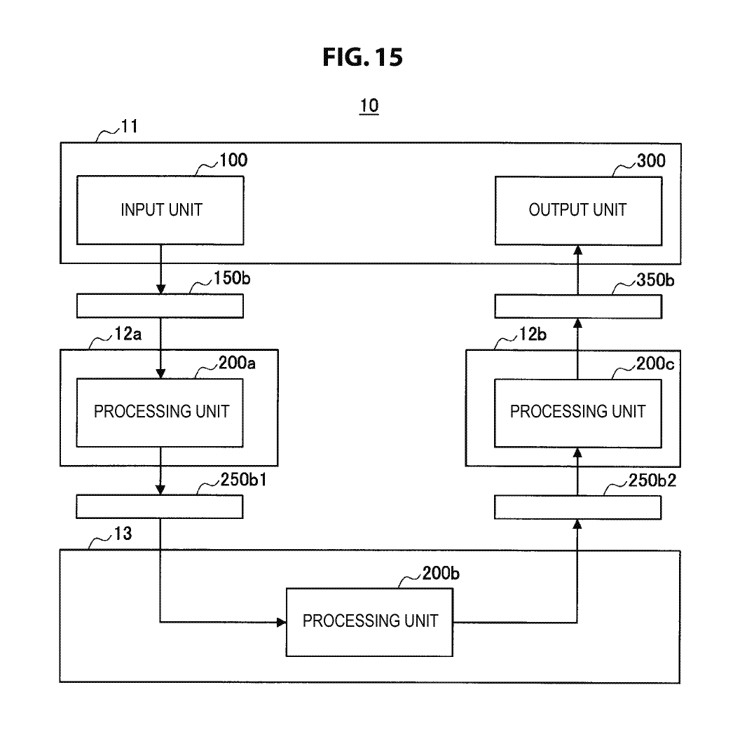

FIG. 15 is a block diagram illustrating an eighth example of the system configuration of an embodiment of the present disclosure. Referring to FIG. 15, the system 10 includes information processing apparatuses 11, 12a, 12b and 13. The input unit 100 and the output unit 300 are realized in the information processing apparatus 11, whereas the processing unit 200 is realized by being distributed in the information processing apparatuses 12a, 12b and 13. The information processing apparatus 11 communicates with the information processing apparatuses 12a and 12b and the information processing apparatuses 12a and 12b communicate with the information processing apparatus 13 via a network in order to implement functions according to the embodiment of the present disclosure.

In the eighth example, the processing unit 200a which performs pre-processing and the processing unit 200c which performs post-processing in the aforementioned sixth example are respectively implemented by the individual information processing apparatuses 12a and 12b. Accordingly, the information processing apparatus 11 and the information processing apparatus 13 are the same as those in the sixth example. In addition, the information processing apparatuses 12a and 12b may be servers or terminal devices. For example, any of the information processing apparatuses 12a and 12b is a server, it may be said that the processing unit 200 is implemented by being distributed in three servers (information processing apparatuses 12a, 12b and 13) in the system 10. The number of servers that realize the processing unit 200 in a distributed manner is not limited to 3 and may be 2 or 4 or more. Illustration of such examples is omitted since the examples may be understood from, for example, the eighth example or a ninth example which will be described below.

### Ninth Example

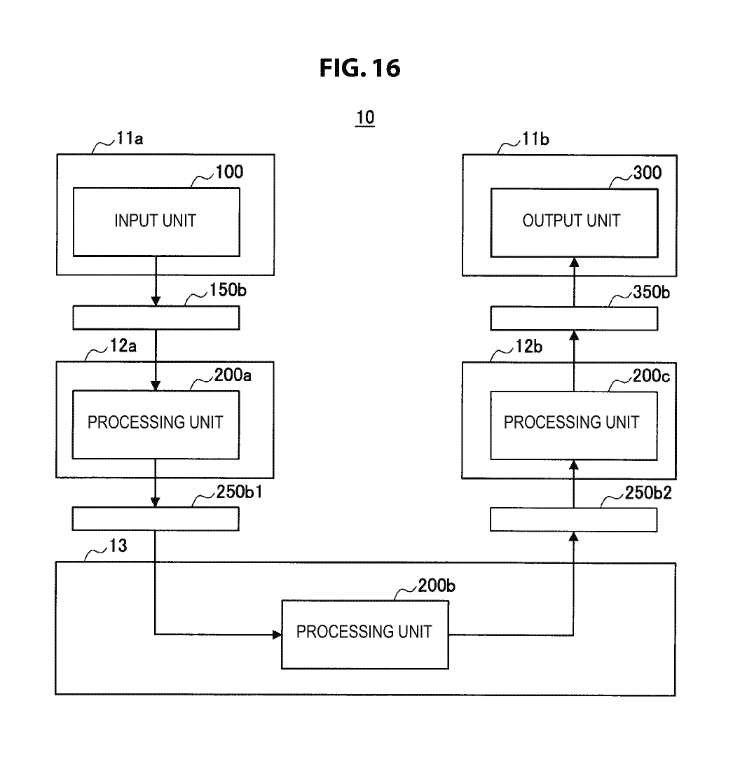

FIG. 16 is a block diagram illustrating a ninth example of the system configuration of an embodiment of the present disclosure. Referring to FIG. 16, the system 10 includes information processing apparatuses 11a, 11b, 12a, 12b and 13. In the ninth example, the input unit 100 is realized in the information processing apparatus 11a and the output unit 300 is realized in the information processing apparatus 11b. The processing unit 200 is realized by being distributed in the information processing apparatuses 12a, 12b and 13. The information processing apparatus 11a communicates with the information processing apparatus 12a, the information processing apparatus 11b communicates with the information processing apparatus 12b and the information processing apparatuses 12a and 12b communicate with the information processing apparatus 13 via a network in order to implement functions according to the embodiment of the present disclosure.

The ninth example corresponds to a combination of the aforementioned seventh and eighth examples. That is, the information processing apparatus 11a realizing the input unit 100 and the information processing apparatus 11b realizing the output unit 300 are separate apparatuses in the ninth example. The information processing apparatuses 11a and 11b respectively communicate with individual intermediate nodes (information processing apparatuses 12a and 12b). Accordingly, the processing unit 200 is implemented by being distributed in three servers (information processing apparatuses 12a, 12b and 13), as in the aforementioned eighth example, and functions according to the embodiment of the present disclosure may be realized using the information processing apparatuses 11a and 11b which may be terminal devices carried or used by the same user or different users in the ninth example.

### (Example of System Including Intermediate Server)

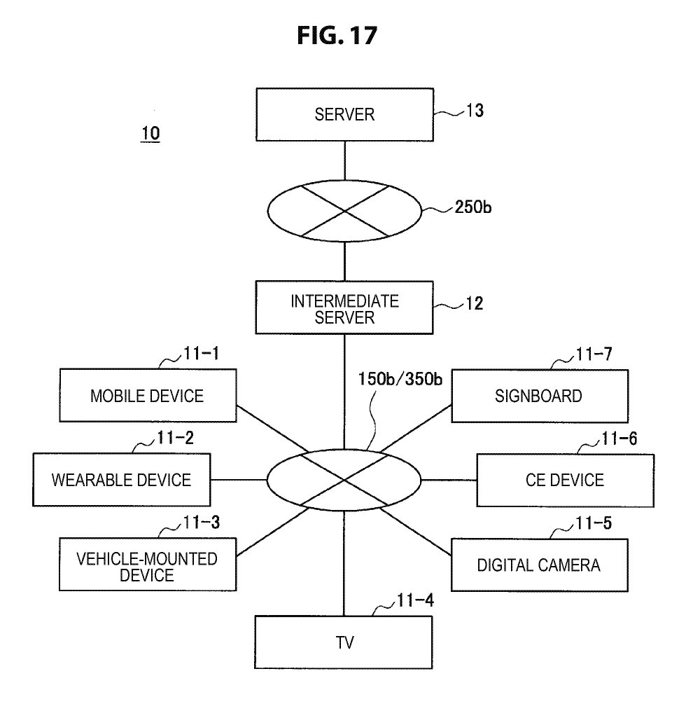

FIG. 17 is a diagram illustrating a system including an intermediate server as a detailed example of the system configuration according to an embodiment of the present disclosure. In the illustrated example, the information processing apparatus 11 (or information processing apparatuses 11a and 11b) is a terminal device, the information processing apparatus 12 is an intermediate server and the information processing apparatus 13 is a server.

As in the aforementioned example described with reference to FIG. 12, the terminal device may include a mobile device 11-1, a wearable device 11-2, a vehicle mounted device 11-3, a TV 11-4, a digital camera 11-5, a CE device 11-6, a robot device, a signboard 11-7, etc. The information processing apparatus 11 (terminal device) communicates with the information processing apparatus 12 (intermediate server) via a network. The network between the terminal device and the intermediate server corresponds to the interfaces 150b and 350b in the aforementioned examples. In addition, the information processing apparatus 12 (intermediate server) communicates with the information processing apparatus 13 (server) via a network. The network between the intermediate server and the server corresponds to the interface 250b in the aforementioned examples.

The example of FIG. 17 is illustrated in order to aid in easily understanding an example in which the system 10 is implemented as a system including the intermediate server, and the system 10 is not limited to such system as described in the aforementioned examples.

### (Example of System Including Terminal Device Serving as Host)

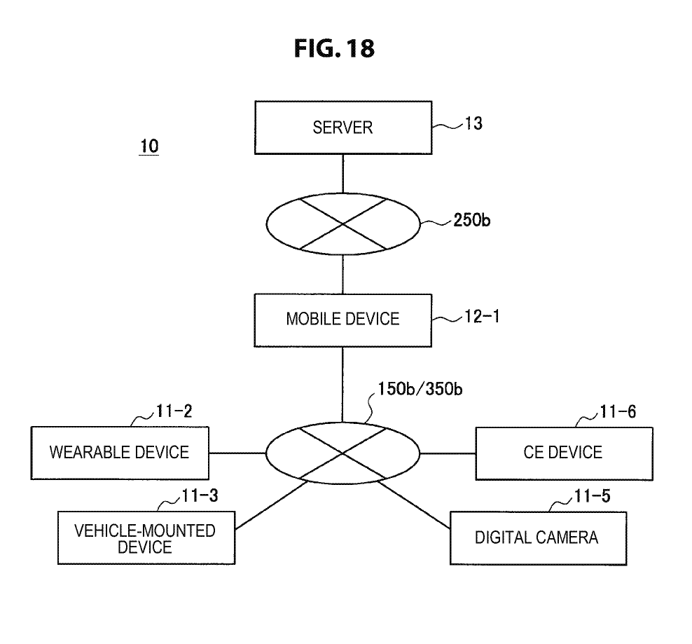

FIG. 18 is a diagram illustrating an example of a system including a terminal device serving as a host, as a detailed example of the system configuration according to an embodiment of the present disclosure. In the illustrated example, the information processing apparatus 11 (or information processing apparatuses 11a and 11b) is a terminal device, the information processing apparatus 12 is a terminal device serving as a host and the information processing apparatus 13 is a server.

In the illustrated example, the terminal device may include a wearable device 11-2, a vehicle mounted device 11-3, a digital camera 11-5, a robot device, a device including a sensor provided to equipment and a CE device 11-6, for example. The information processing apparatus 11 (terminal device) communicates with the information processing apparatus 12 via a network such as Bluetooth (registered trademark) or Wi-Fi, for example. The figure illustrates the mobile device 12-1 as the terminal device serving as a host. The network between the terminal device and the mobile device corresponds to the interfaces 150b and 350b in the aforementioned examples. The information processing apparatus 12 (mobile device) communicates with the information processing apparatus 13 (server) via a network, for example, the Internet. The network between the mobile device and the server corresponds to the interface 250b in the aforementioned examples.

The example of FIG. 18 is illustrated in order to aid in easily understanding an example in which the system 10 is implemented as a system including a terminal device serving as a host, and the system 10 is not limited to such system as described in the aforementioned examples. In addition, the terminal device serving as a host is not limited to the mobile device 12-1 in the illustrated example and various terminal devices having an appropriate communication function and processing function may serve as a host. Furthermore, the wearable device 11-2, the vehicle mounted device 11-3, the digital camera 11-5 and the CE device 11-6 illustrated as examples of the terminal device do not exclude terminal devices other than these devices from this example and represent examples of a typical terminal device which may be the information processing apparatus 11 when the information processing apparatus 12 is the mobile device 12-1.

### Tenth Example

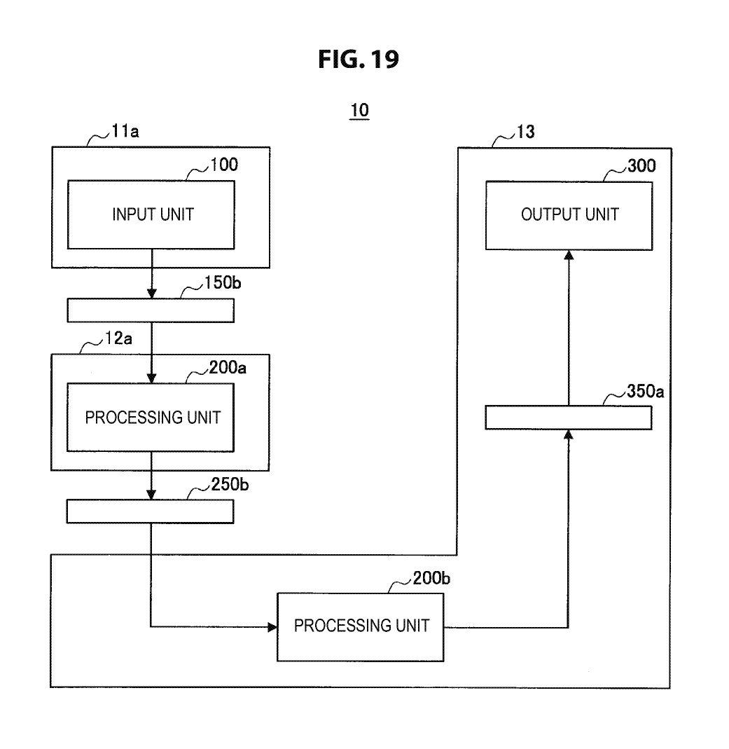

FIG. 19 is a block diagram illustrating a tenth example of the system configuration according to an embodiment of the present disclosure. Referring to FIG. 19, the system 10 includes information processing apparatuses 11a, 12a and 13. In the tenth example, the input unit 100 is realized in the information processing apparatus 11a. The processing unit 200 is realized by being distributed in the information processing apparatuses 12a and 13. The output unit 300 is realized in the information processing apparatus 13. The information processing apparatus 11a communicates with the information processing apparatus 12a and the information processing apparatus 12a communicates with the information processing apparatus 13 via a network in order to implement functions according to the embodiment of the present disclosure.

The tenth example is an example in which the information processing apparatuses 11b and 12b in the aforementioned ninth example are integrated into the information processing apparatus 13. That is, the information processing apparatus 11a realizing the input unit 100 and the information processing apparatus 12a realizing the processing unit 200a are independent apparatuses, whereas the processing unit 200b and the output unit 300 are implemented by the same information processing apparatus 13 in the tenth example.

The tenth example realizes a configuration in which information acquired by the input unit 100 in the information processing apparatus 11a corresponding to a terminal device, for example, is processed by the processing unit 200a of the information processing apparatus 12a corresponding to an intermediate terminal device or a server, provided to the information processing apparatus 13 corresponding to a server or a terminal, processed by the processing unit 200b and output from the output unit 300. Intermediate processing by the information processing apparatus 12a may be omitted. This configuration may be employed in, for example, a service of performing a predetermined process in the server or terminal 13 on the basis of the information provided by the terminal device 11a and then accumulating or outputting a processing result in the server or terminal 13. The accumulated processing result may be used by other services, for example.

### Eleventh Example

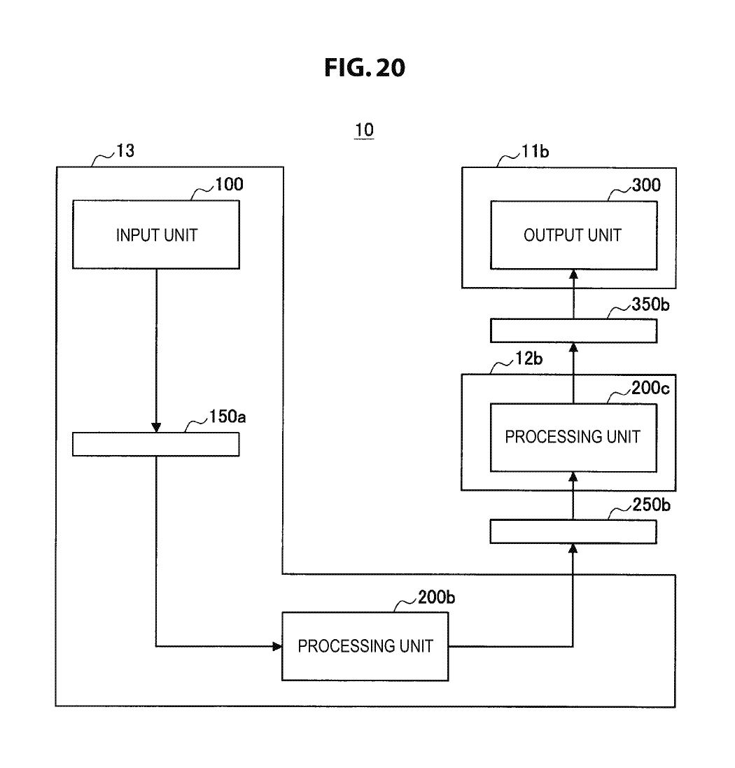

FIG. 20 is a block diagram illustrating an eleventh example of the system configuration according to an embodiment of the present disclosure. Referring to FIG. 20, the system 10 includes information processing apparatuses 11b, 12b and 13. In the eleventh example, the input unit 100 is realized in the information processing apparatus 13. The processing unit 200 is realized by being distributed in the information processing apparatuses 13 and 12b. The output unit 300 is realized in the information processing apparatus 11b. The information processing apparatus 13 communicates with the information processing apparatus 12b and the information processing apparatus 12b communicates with the information processing apparatus 11b via a network in order to implement functions according to the embodiment of the present disclosure.

The eleventh example is an example in which the information processing apparatuses 11a and 12a in the aforementioned ninth example are integrated into the information processing apparatus 13. That is, the information processing apparatus 11b realizing the output unit 300 and the information processing apparatus 12b realizing the processing unit 200c are independent apparatuses, whereas the input unit 100 and the processing unit 200b are implemented by the same information processing apparatus 13 in the eleventh example.

The eleventh example realizes a configuration in which information acquired by the input unit 100 in the information processing apparatus 13 corresponding to a server or a terminal device, for example, is processed by the processing unit 200b, provided to the information processing apparatus 12b corresponding to an intermediate terminal device or a server, processed by the processing unit 200c and output from the output unit 300 in the information processing apparatus 11b corresponding to a terminal device. Intermediate processing by the information processing apparatus 12b may be omitted. This configuration may be employed in, for example, a service of performing a predetermined process in the server or terminal 13 on the basis of information acquired in the server or terminal 13 and then providing a processing result to the terminal device 11b. The acquired information may be provided by other services, for example.

### 6. HARDWARE CONFIGURATION

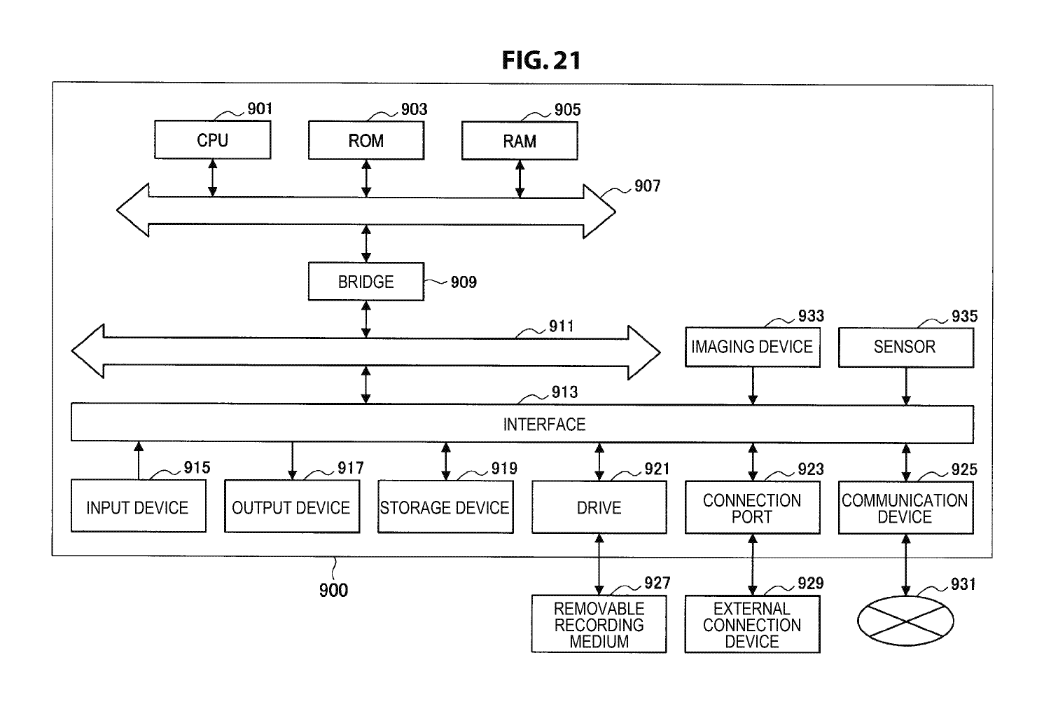

Next, with reference to FIG. 21, a hardware configuration of an information processing apparatus according to an embodiment of the present disclosure will be described. FIG. 21 is a block diagram showing a hardware configuration of an information processing apparatus according to an embodiment of the present disclosure.

The information processing apparatus 900 includes a central processing unit (CPU) 901, read only memory (ROM) 903, and random access memory (RAM) 905. Further, the information processing apparatus 900 may also include a host bus 907, a bridge 909, an external bus 911, an interface 913, an input device 915, an output device 917, a storage device 919, a drive 921, a connection port 923, and a communication device 925. Furthermore, the information processing apparatus 900 may include an imaging device 933 and a sensor 935 as necessary. The information processing apparatus 900 may also include, instead of or along with the CPU 901, a processing circuit such as a digital signal processor (DSP), an application specific integrated circuit (ASIC), or a field-programmable gate array (FPGA).

The CPU 901 functions as an arithmetic processing unit and a control unit and controls an entire operation or a part of the operation of the information processing apparatus 900 according to various programs recorded in the ROM 903, the RAM 905, the storage device 919, or a removable recording medium 927. The ROM 903 stores programs and arithmetic parameters used by the CPU 901. The RAM 905 primarily stores programs used in execution of the CPU 901 and parameters and the like varying as appropriate during the execution. The CPU 901, the ROM 903, and the RAM 905 are connected to each other via the host bus 907 configured from an internal bus such as a CPU bus or the like. In addition, the host bus 907 is connected to the external bus 911 such as a peripheral component interconnect/interface (PCI) bus via the bridge 909.

The input device 915 is a device operated by a user, such as a mouse, a keyboard, a touch panel, buttons, a switch, and a lever. Also, the input device 915 may be a remote control device using, for example, infrared light or other radio waves, or may be an external connection device 929 such as a cell phone compatible with the operation of the information processing apparatus 900. The input device 915 includes an input control circuit that generates an input signal on the basis of information input by the user and outputs the input signal to the CPU 901. The user inputs various kinds of data to the information processing apparatus 900 and instructs the information processing apparatus 900 to perform a processing operation by operating the input device 915.

The output device 917 includes a device capable of notifying a user of the acquired information visually, audibly or with a tactile sense. Examples of the output device 917 include display devices such as a liquid crystal display (LCD) or an organic electro-luminescence (EL) display, audio output devices such as a speaker and a headphone, and a vibrator. The output device 917 outputs a result obtained through the process of the information processing apparatus 900 as a picture such as text or an image, as an audio such as a voice or an acoustic sound, or as vibration.

The storage device 919 is a device for storing data configured as an example of a storage unit of the information processing apparatus 900. The storage device 919 is configured from, for example, a magnetic storage device such as a hard disk drive (HDD), a semiconductor storage device, an optical storage device, or a magneto-optical storage device. This storage device 919 stores programs to be executed by the CPU 901, various data, and various data obtained from the outside.

The drive 921 is a reader/writer for the removable recording medium 927 such as a magnetic disk, an optical disc, a magneto-optical disk, or a semiconductor memory, and is built in or externally attached to the information processing apparatus 900. The drive 921 reads out information recorded on the attached removable recording medium 927, and outputs the information to the RAM 905. Further, the drive 921 writes the record on the attached removable recording medium 927.

The connection port 923 is a port for allowing devices to connect to the information processing apparatus 900. Examples of the connection port 923 include a universal serial bus (USB) port, an IEEE1394 port, and a small computer system interface (SCSI) port. Other examples of the connection port 923 may include an RS-232C port, an optical audio terminal, and a high-definition multimedia interface (HDMI) (a registered trademark) port. The connection of the external connection device 929 to the connection port 923 may enable the various data exchange between the information processing apparatus 900 and the external connection device 929.

The communication device 925 is a communication interface configured from, for example, a communication device for establishing a connection to a communication network 931. The communication device 925 is, for example, a local area network (LAN), Bluetooth (registered trademark), Wi-Fi, a communication card for wireless USB (WUSB), or the like. Alternatively, the communication device 925 may be a router for optical communication, a router for asymmetric digital subscriber line (ADSL), a modem for various communications, or the like. The communication device 925 can transmit and receive signals and the like using a certain protocol such as TCP/IP on the Internet and with other communication devices, for example. The communication network 931 connected to the communication device 925 is configured from a network which is connected via wire or wirelessly and is, for example, the Internet, a home-use LAN, infrared communication, radio wave communication, and satellite communication.

The imaging device 933 is a device which images a real space by use of various members including an image sensor such as a complementary metal oxide semiconductor (CMOS) or a charge coupled device (CCD) and a lens for controlling image formation of a subject on the image sensor, and generates a pickup image. The imaging device 933 may image a still image or a moving image.

Examples of the sensor 935 include various sensors such as an acceleration sensor, an angular velocity sensor, a geomagnetic sensor, an illuminance sensor, a temperature sensor, a barometric sensor or an audio sensor (a microphone). The sensor 935 acquires, for example, information regarding a posture state of the information processing apparatus 900, such as a posture of the casing of the information processing apparatus 900 or information regarding a surrounding environment of the information processing apparatus 900, such as brightness or noise of the surroundings of the information processing apparatus 900. Also, the sensor 935 may include a Global Positioning System (GPS) receiver that receives GPS signals and measures the latitude, longitude, and altitude of the device.

Heretofore, an example of the hardware configuration of the information processing apparatus 900 has been shown. Each of the structural elements described above may be configured using a general-purpose material, or may be configured from hardware dedicated to the function of each structural element. The configuration may be changed as appropriate according to the technical level at the time of carrying out embodiments.

### 7. SUPPLEMENT

The embodiments of the present disclosure may include the information processing apparatus, the system, the information processing method executed in the information processing apparatus or the system, the program for causing the information processing apparatus to function, and the non-transitory tangible media having the program recorded thereon, which have been described above, for example.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing apparatus including:

a status information acquisition unit configured to acquire information representing a first situation of a user and information representing a second situation of the user;

a status feature quantity extraction unit configured to extract a first status feature quantity corresponding to the first situation and a second status feature quantity corresponding o the second situation;

a result information acquisition unit configured to acquire information indicating a first result generated in the first situation;

a result feature quantity extraction unit configured to extract a result feature quantity corresponding to the first result;

a relation feature quantity generation unit configured to generate a relation feature quantity indicating a relation between the first situation and the first result on the basis of the first status feature quantity and the result feature quantity;

a result estimation unit configured to estimate a second result generated in the second situation on the basis of the relation feature quantity and the second status feature quantity; and

an information generation unit configured to generate information reflecting the second result.

(2)

The information processing apparatus according to (1), wherein the second situation occurs in a scene different from the first situation.

(3)

The information processing apparatus according to (1), wherein the second result is related to an action of the user, and

the information generation unit generates information including navigation for the action of the user.

(4)

The information processing apparatus according to any one of (1) to (3), wherein the result information acquisition unit acquires information indicating a change in the first situation as the information indicating the first result.

(5)

The information processing apparatus according to any one of (1) to (4), wherein the result information acquisition unit acquires information indicating a sporadic event generated in the first situation as the information indicating the first result.

(6)

The information processing apparatus according to any one of (1) to (5), wherein the result information acquisition unit acquires information of a different type from information acquired by the status information acquisition unit.

(7)

The information processing apparatus according to (6), wherein the result information acquisition unit acquires information provided by a sensor different from that for the status information acquisition unit.

(8)

An information processing method including:

acquiring information representing a first situation of a user and information representing a second situation of the user;

extracting a first status feature quantity corresponding to the first situation and a second status feature quantity corresponding o the second situation;

acquiring information indicating a first result generated in the first situation;

extracting a result feature quantity corresponding to the first result;

generating a relation feature quantity indicating a relation between the first situation and the first result on the basis of the first status feature quantity and the result feature quantity;

estimating, by a processor, a second result generated in the second situation on the basis of the relation feature quantity and the second status feature quantity; and

generating information reflecting the second result.

(9)

A program for causing a computer to execute functions of:

acquiring information representing a first situation of a user and information representing a second situation of the user;

extracting a first status feature quantity corresponding to the first situation and a second status feature quantity corresponding o the second situation of the user;

acquiring information indicating a first result generated in the first situation;

extracting a result feature quantity corresponding to the first result;

generating a relation feature quantity indicating a relation between the first situation and the first result on the basis of the first status feature quantity and the result feature quantity;

estimating a second result generated in the second situation on the basis of the relation feature quantity and the second status feature quantity; and

generating information reflecting the second result.

### REFERENCE SIGNS LIST

10 system
11, 12, 13 information processing apparatus
100 input unit
150, 250, 350 interface
200 processing unit
201 status information acquisition unit
203 status feature quantity extraction unit
205 result information acquisition unit
207 result feature quantity extraction unit
209 relation feature quantity generation unit
211 result estimation unit
213 information generation unit
300 output unit

1. An information processing apparatus comprising:
a status information acquisition unit configured to acquire information representing a first situation of a user and information representing a second situation of the user;
a status feature quantity extraction unit configured to extract a first status feature quantity corresponding to the first situation and a second status feature quantity corresponding o the second situation;
a result information acquisition unit configured to acquire information indicating a first result generated in the first situation;
a result feature quantity extraction unit configured to extract a result feature quantity corresponding to the first result;
a relation feature quantity generation unit configured to generate a relation feature quantity indicating a relation between the first situation and the first result on the basis of the first status feature quantity and the result feature quantity;
a result estimation unit configured to estimate a second result generated in the second situation on the basis of the relation feature quantity and the second status feature quantity; and
an information generation unit configured to generate information reflecting the second result.

2. The information processing apparatus according to claim 1, wherein the second situation occurs in a scene different from the first situation.

3. The information processing apparatus according to claim 1, wherein the second result is related to an action of the user, and
the information generation unit generates information including navigation for the action of the user.

4. The information processing apparatus according to claim 1, wherein the result information acquisition unit acquires information indicating a change in the first situation as the information indicating the first result.

5. The information processing apparatus according to claim 1, wherein the result information acquisition unit acquires information indicating a sporadic event generated in the first situation as the information indicating the first result.

6. The information processing apparatus according to claim 1, wherein the result information acquisition unit acquires information of a different type from information acquired by the status information acquisition unit.

7. The information processing apparatus according to claim 6, wherein the result information acquisition unit acquires information provided by a sensor different from that for the status information acquisition unit.

8. An information processing method comprising:
acquiring information representing a first situation of a user and information representing a second situation of the user;
extracting a first status feature quantity corresponding to the first situation and a second status feature quantity corresponding o the second situation;
acquiring information indicating a first result generated in the first situation;
extracting a result feature quantity corresponding to the first result;
generating a relation feature quantity indicating a relation between the first situation and the first result on the basis of the first status feature quantity and the result feature quantity;
estimating, by a processor, a second result generated in the second situation on the basis of the relation feature quantity and the second status feature quantity; and
generating information reflecting the second result.

9. A program for causing a computer to execute functions of:
acquiring information representing a first situation of a user and information representing a second situation of the user;
extracting a first status feature quantity corresponding to the first situation and a second status feature quantity corresponding o the second situation of the user;
acquiring information indicating a first result generated in the first situation;
extracting a result feature quantity corresponding to the first result;
generating a relation feature quantity indicating a relation between the first situation and the first result on the basis of the first status feature quantity and the result feature quantity;
estimating a second result generated in the second situation on the basis of the relation feature quantity and the second status feature quantity; and
generating information reflecting the second result.
